(19) United States
(12) Patent Application Publication
(10) Pub. No.: US 2026/0214118 A1
(43) Pub. Date: Jul. 23, 2026

(54) METHOD TO ENABLE AND PREVENT CALLBACK PHISHING

(71) Applicant: Cisco Technology, Inc., San Jose, CA (US)

(72) Inventor: Suresh Gopathy, Alpharetta, GA (US)

(21) Appl. No.: 19/033,363

(22) Filed: Jan. 21, 2025

(51) Int. Cl. H04L 9/40; H04L 61/4511

(52) U.S. Cl. CPC H04L 63/1483; H04L 61/4511

(57) ABSTRACT

Techniques for enabling and preventing callback phishing are described herein. An email security system may be configured determine a callback intent of an email containing a phone number. Further, the email security system may determine a domain associated with the email, and retrieve a phone number associated with the domain. Based on a correlation between the email phone number of the email and the domain phone number, the phone number included in the email may be validated, and the email classified accordingly. Further, a telecommunication security service may use the phone number of a callback communication to identify the domain, identify a phone number associated with the sending domain, and correlate the callback phone number with the domain phone number. The phone number may similarly be validated, and the callback classified.

### TECHNICAL FIELD

The present disclosure relates generally to techniques for an email security system and/or security platform to enable and prevent callback phishing attacks.

### BACKGROUND

Electronic messages and mail, or “email,” continue to be a primary method of exchanging messages between users of electronic devices. Many email service providers have emerged that provide users with a variety of email platforms to facilitate the communication of emails via email servers that accept, forward, deliver, and store messages for the users. Email continues to be a fundamental method of communication between users of electronic devices as email provides users with a cheap, fast, accessible, efficient, and effective way to transmit all kinds of electronic data. Email is well established as a means of day-to-day, private communication for business communications, marketing communications, social communications, educational communications, and many other types of communications. Additionally, the use of responses to telecommunications, such as callbacks, are often used by entities if a telephone line is busy, there are no agents available to take a customer call, or a customer requests a callback to avoid remaining on hold.

Due to the widespread use and necessity of email, hackers and other malicious entities use email as a primary channel for delivering different types of attacks. For example, email and/or electronic messages may include attempts for phishing (e.g., the act of attempting to acquire information from users, such as usernames, passwords, or payment information, by posing as a trustworthy entity, colleague, etc. in a message). In another example, email and/or electronic messages may include malware (e.g., software intentionally designed to cause damage to an electronic device) may be sent to the electronic device using messages. Often times, these attacks are performed using uniform resource locators (URLs) that are included within an email. Additionally, email and/or electronic messages may include attempts for callback phishing, where an email may include a phone number for a receiving user to call while the malicious sender poses as a legitimate source (e.g., healthcare organization, government agency, bank, etc.), and uses social engineering techniques to obtain phishing information while on a call with the receiving user.

In some instances, cloud messaging services provide secure email gateways (SEGs) that monitor emails for malicious content and implement pre-delivery protection by blocking email-based threats before they reach a mail server. These SEGs can scan incoming, outgoing, and internal communications for signs of malicious or harmful content. However, once the receiving user of a callback phishing email engages in a telephone call with a malicious sender, the telephone call is outside the scope of SEG protection. Further, the use of callbacks in telecommunications may not always be associated with a callback phishing attempt; entities may use callback techniques for business efficiencies. However, malicious entities may take advantage of these callbacks, and a receiving user may be unable to discern whether a callback from a purported entity is legitimate.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example environment in which an email security system validates a callback phone number in incoming emails, and processes the emails accordingly.

FIG. 2 illustrates an example environment in which a telecommunications security system validates a callback phone number in incoming and/or outgoing calls, and processes the calls accordingly.

FIG. 3 illustrates a diagram of example components of the email security system.

FIG. 4 illustrates a diagram of example components of the telecommunications security system.

FIG. 5 illustrates a flow diagram of an example process for using email metadata to validate a callback phone number included in an email.

FIG. 6 illustrates a flow diagram of an example process for using a callback phone number to retrieve DNS records and validate the callback phone number.

FIG. 7 illustrates a flow diagram of an example process for enabling and preventing callback phishing in incoming emails.

FIG. 8 illustrates a flow diagram of an example process for enabling and preventing callback phishing in telecommunications.

FIG. 9 illustrates a computing system diagram illustrating a configuration for a data center that can be utilized to implement aspects of the technologies disclosed herein.

FIG. 10 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This disclosure describes techniques for email security system and/or security platform to enable and prevent callback phishing attacks. A method to perform the techniques described herein includes receiving, at a secure email gateway, an email to be processed and delivered to a user account of an email service, wherein the email is associated with an indication of a first phone number. The method further includes determining, based at least in part on first metadata extracted from the email, a callback intent associated with the email, and determining, based at least in part on second metadata extracted from the email, a sending domain associated with the email. The method may also include determining, a second phone number associated with the sending domain, and determining whether there is an association between the first phone number and the second phone number. The method may include processing, by the secure email gateway, the email based at least in part on the association.

An additional method to perform the techniques described herein includes receiving, at a user device, a callback communication, wherein the callback communication is associated with a first phone number. The method further includes determining, by a telecommunication security service, a sending domain associated with the first phone number, and determining, based at least in part on the sending domain, a second phone number. The method may also include determining whether there is an association between the first phone number and the second phone number. The method may include processing, by the telecommunication security service, the callback communication based at least in part on the association.

Additionally, the techniques described herein may be performed by a system and/or device having non-transitory computer-readable media storing computer-executable instructions that, when executed by one or more processors, performs the method described above.

### Example Embodiments

Various implementations of the present disclosure provide techniques for enabling and preventing callback phishing in incoming emails and/or telecommunications based at least in part on a phone number included in the email. As discussed above, due to the widespread use and necessity of email, hackers and other malicious entities use email as a primary channel for delivering different types of attacks. For example, email and/or electronic messages may include attempts for phishing (e.g., the act of attempting to acquire information from users, such as usernames, passwords, or payment information, by acting as a trustworthy entity in a message). Related to phishing attempts include callback phishing, where an email may include a phone number for a receiving user to call while the malicious sender poses as a legitimate source (e.g., healthcare organization, government agency, bank, etc.), and uses social engineering techniques to obtain phishing information while on a call with the receiving user.

While secure email gateways (SEGs) may monitor emails for malicious content and implement pre-delivery protection by blocking email-based threats before they reach a mail server, once the receiving user of a callback phishing email engages in a telephone call with a malicious sender, the telephone call is outside the scope of the SEG protection. Additionally, SEGs are unable to convict an incoming email as being associated with callback phishing due to a high false positive rate associated with callback phishing (e.g., an incoming email with a callback phone number may be associated with a genuine entity). In some instances, entities may wish to use callback techniques for business efficiencies (e.g., provide flexibility for customers on hold, decrease number of agents required to answer calls, etc.). However, malicious entities may take advantage of these callbacks, and a receiving user may be unable to discern whether a callback from a purported entity is legitimate. Due to the targeting of callbacks, a genuine entity may wish to build trust with their receiving users when sending emails containing a callback number and/or engaging in a callback.

Accordingly, a need exists for systems and methods enabling an intelligent way to enable genuine entities to authenticate their callback phone numbers, such that an email security system (e.g., SEG) and/or telecommunications security system (e.g., mobile application on receiving device) to validate the authenticity of a phone number included in an email and/or used in a callback.

According to the techniques described herein, an email security system may receive an email that is to be delivered to a receiving user of an email service platform. The email security platform may extract metadata from the email, such as the subject of the email, contents of the email, sender information, etc. Based on the email metadata, the email security system may determine an intent associated with the email (e.g., whether the email is associated with a callback attempt). In some instances, the email may include an indication of a phone number, with instructions requesting that the receiving user call the phone number to engage regarding the subject matter of the email (e.g., a callback attempt). Further, based on the email metadata, the email security system may be configured to identify a sending domain associated with the email.

Additionally, based on the email being associated with a callback intent, the email security system may be configured to extract and/or receive a phone number associated with the sending domain. For example, the email security system may be configured to query a domain name system (DNS) (e.g., query DNS records). In some instances, DNS records may include DNS TXT records, where the DNS TXT records include information provided by the owner of the sending domain. For example, DNS TXT records may include an indication of one or more phone numbers provided by an entity that is the owner of the sending domain. Once one or more phone numbers associated with the sending domain have been extracted and/or received by the email security system, the email security system may be configured to validate the phone number included in the email. By way of example, and not limitation, the email security system may be configured to validate the phone number included in the email by determining whether the phone number is included as part of the DNS TXT record associated with the sending domain. If there is a match, or association, between phone numbers and/or the phone number included in the email has been validated, the email security system may classify the incoming email as being associated with a legitimate callback attempt. Additionally, or alternatively, if there is no association and/or the phone number included in the email has not been validated, the email security system may classify the incoming email as potentially malicious.

Based on the validation of a phone number included in an email, or lack thereof, the email security system may determine whether to transmit the email to the receiving user, or perform a remedial action regarding the email (e.g., quarantine the email). In this way, the email security system is able to classify emails as including a callback phishing attempt, and prevent potential malicious attacks on users, with high confidence. Additionally, the email security system may also enable the legitimate use of callbacks by genuine entities. The reliance on phone number validation may enable the email security system to rely less on determining malicious intent associated with the email, and thus require fewer instances of computing resources (e.g., CPU, GPU, RAM, etc.) and/or computing power to determine malicious intent.

Additionally, according to the techniques described herein, a telecommunications security system may receive an indication of a callback communication between a sending device and a receiving device. For example, the indication of the callback communication may include an incoming callback from the sending device and/or the dialing of a callback phone number by the receiving device. The telecommunications security system may determine a phone number associated with the callback. Additionally, or alternatively, based on the phone number associated with the callback, the telecommunications security system may be configured to determine a sending domain associated with the phone number. For example, the telecommunications security system may extract and/or receive an indication of the sending domain associated with the phone number from a reverse phone number database (e.g., provided by a third-party, ISP, etc.). The telecommunications security system may query, or perform a reverse look-up, such that a sending domain may be determined based on the phone number of the callback.

Further, as described above, the telecommunications security system may be configured to use the determined sending domain to query DNS records, where the DNS records may include DNS TXT records (e.g., with information provided by the owner of the sending domain, such as one or more phone numbers provided by the entity that is the owner). Once one or more phone numbers associated with the sending domain have been extracted and/or received by the telecommunications security system, the telecommunications security system may be configured to validate the phone number associated with the callback. By way of example, and not limitation, the telecommunications security system may be configured to validate the phone number of the callback by determining whether the phone number is included as part of the DNS TXT record associated with the sending domain (e.g., the sending domain determined from the initial phone number). Based on the validation of a phone number of the callback, or lack thereof, the telecommunications security system may determine whether to connect the callback communication between devices, or perform a remedial action regarding the callback (e.g., disconnect the call, cause a notification to be displayed at the user device, etc.).

As described herein, the term “malicious” may be applied to data, actions, attackers, entities, emails, etc., and the term “malicious” may generally correspond to spam, phishing, callback phishing, spoofing, malware, viruses, and/or any other type of data, entities, or actions that may be considered or viewed as unwanted, negative, harmful, etc. for a recipient user and/or destination email address associated with an email communication.

To implement the techniques described herein, an email service platform may use, or work in combination with, an email security system. The email security system (e.g., a SEG), may receive, or intercept, emails and/or other types of electronic communications that are to be communicated to users of the email service platform, such as being stored at a location that is accessible to the users via their respective inboxes. After receiving an email for a user (e.g., a receiving user) of the email service platform, the email security system may be configured to extract email metadata associated with the email. Email metadata may include, for example, indications of “From-Field” addresses and/or names for the email, “To-Field” addresses for the email, a “Subject” of the email, a Date/Time the email was communicated, hashes of attachments to the email, URLs in the body of the email, Internet Protocol (IP) addresses associated with the email, and/or a domain associated with the email (e.g., the email server associated with an email address). In some instances, the metadata may additionally, or alternatively, include content included in the body of the email, actual attachments to the email, and/or other data of the email. Further, the metadata extracted from the email may generally be any probative information for the email security system to determine a callback intent associated with the email.

The email security system may be configured to determine a callback intent of an incoming email based on the email metadata, and in turn, validate a callback phone number included in the email. The email metadata may be processed using security analysis techniques to determine whether the email is associated with a callback (e.g., the callback intent). For example, the email security system may determine that the email includes an indication of a phone number, with instructions requesting that the receiving user call the phone number to engage regarding the subject matter of the email (e.g., a callback attempt). The determination of the callback intent of the email may be represented as a general result (e.g., potentially a callback, not a callback, etc.) or a probability score indicative of a likelihood of a callback intent, and/or the like.

As described above, the email received, or intercepted, by the email security system may be designed to engage the receiving user in a callback. For instance, the email may include a request for a confirmation of a delivery, a notification regarding a bank account transaction, a list of unpaid invoices, sensitive information, and/or the like. Further, the email may include, along with the request, notification, etc., an indication of the phone number for the user to engage with. For example, the email may appear to be from the receiving user's bank, include a notification that a certain amount of funds is going to be withdrawn from a user account, as well as a phone number to call if the withdrawal is an error. In some instances, the phone number may be included within the body of the email, an attachment to the email, URLs included with the email, and/or the like.

Additionally, or alternatively, the email security system may be configured to determine a phone number associated with a sending domain of the email. As described above, email metadata may include an indication of a sending domain. For example, a sending domain may include indications such as “acmebank.com” for a sending email address of “john@acmebank.com.” Based on the sending domain, the email security system may be configured to receive and/or extract a phone number associated with the sending domain from one or more sources. For example, phone numbers associated with sending domains may be aggregated and stored at a single location (e.g., a datastore). Such a datastore may be associated with a domain name system (DNS) (e.g., the email security system may query DNS records to extract and/or receive a phone number associated with the sending domain). The DNS may be provided by a third-party, internet service provider (ISP), and/or the like. In some instances, DNS records may include DNS TXT records, where the DNS TXT records include information provided by the owner of the sending domain. For example, DNS TXT records may include an indication of one or more phone numbers provided by an entity that is the owner of the sending domain. Phone numbers included in DNS TXT records may be those to be authenticated as legitimate and associated with the entity (e.g., phone numbers used by the entity when engaging in callbacks with customers). DNS records may also include digital certificates authenticating the DNS TXT records (e.g., Verified Mark Certificates (VMCs)). For example, DNS TXT records associated with the sending domain of “acmebank.com” may include an indication of phone numbers such as +1 (123) 456-7890 and +1 (999) 999-9999 that are legitimate callback phone numbers of the acmebank.com sending domain.

Once one or more phone numbers associated with the sending domain have been extracted and/or received by the email security system, the email security system may be configured to validate the phone number included in the email. By way of example, and not limitation, the email security system may be configured to validate the phone number included in the email by determining whether the phone number is included as part of the DNS TXT record associated with the sending domain. In other words, the email security system may compare the phone number included in the email to the phone numbers associated with the sending domain to determine whether there is a match. In some instances, the email security system may be configured to determine whether there is an exact match between the phone number included in the email and the phone numbers included in the DNS TXT records of the sending domain. If there is a match, or association, between phone numbers and/or the phone number included in the email has been validated, the email security system may determine that the incoming email is associated with a legitimate callback attempt. Continuing from the example above, if the email from the sending domain of acnmebank.com includes an indication of a phone number such as +1 (999) 999-9990, the email security system may determine that the phone number included in the email is not validated and/or potentially malicious. Additionally, or alternatively, if the email includes an indication of a phone number such as +1 (123) 456-7890, the email security system may determine that the phone number included in the email is validated. In some instances, if there is no association and/or the phone number included in the email has not been validated, the email security system may determine that the incoming email is malicious. In some instances, if it is determined by the email security system that the sending domain has no indication of legitimate phone numbers (e.g., there is no phone number included in a DNS TXT record of the sending domain to be compared to the phone number included in the email), the email security system may rely on other techniques to determine the authenticity of the email (e.g., metadata associated with the email, reputation of the sending domain, etc.). Upon the determination of the validity the phone number included in the email, the email security system may be configured to classify the email as a legitimate callback email (e.g., when there is a match between phone numbers) or a callback phishing attempt email.

Based on the classification of the email (e.g., whether the email is a legitimate callback email or a callback phishing attempt email), the email security system may process the incoming email accordingly. For example, in instances where the email is a legitimate callback email, the email security system may be configured to forward and/or transmit the email to a receiving user such that the email is delivered to the receiving user's inbox. In another example, in instances where the email is a callback phishing attempt email, the email security system may be configured to perform a remedial action with respect to the callback phishing attempt email. Remedial actions may include quarantining, flagging, deleting, and/or dropping the callback phishing attempt email, preventing further communication received from the sender and/or further communication sharing similarities with the callback phishing attempt email, reporting sender information and/or the phone number to authorities, and/or the like.

To implement the techniques described herein, a telecommunications service platform may use, or work in combination with, a telecommunications security system. The telecommunications security system (e.g., an application on a user device) may receive, or intercept, telecommunications and/or other types of communications that are to be communicated to and/or from users of the telecommunications service platform. A user of the telecommunications service platform (e.g., a receiving user) may receive a callback (e.g., returning phone call from call center, doctor's office, entity, etc. subsequent to an initial communication) and or attempt to engage in a telecommunication (e.g., the receiving users dials a callback phone number included in an email). For example, a receiving user may have previously engaged in an initial communication with an entity (e.g., a call center) and is receiving a callback to avoid waiting on hold. In another example, a receiving user may have received an email including a request for a confirmation of delivery, and the user may dial the phone number indicated in the email. After receiving a callback communication to and/or from a user (e.g., a receiving user) of the telecommunications service platform, the telecommunications security system may be configured to extract phone number metadata associated with the callback communication. Phone number metadata may include an indication of a phone number (e.g., the phone number being dialed by the receiving user, the phone number associated with the incoming callback communication to the user, etc.), an indication of an entity that is presented as being associated with the phone number, etc. Based on the phone number metadata, the telecommunications security system may be configured to determine a phone number associated with the callback communication.

Additionally, or alternatively, the telecommunications security system may be configured to determine a sending domain associated with the phone number. For example, a sending domain may include indications such as “acmebank.com.” Based on the phone number, the telecommunications security system may be configured to receive and/or extract a sending domain associated with the phone number from one or more sources. For example, sending domains associated with phone numbers may be aggregated and stored at a single location (e.g., a datastore). Such a datastore may be associated with a DNS (e.g., using a reverse-DNS look-up), a reverse phone number database (e.g., provided by a third-party, ISP, etc.). The telecommunications security system may query, or perform a reverse look-up, such that a sending domain may be determined based on the phone number of the callback. For example, based on a phone number of +1 (111) 111-1111 associated with the callback communication of the receiving user, the telecommunications security system may identify the sending domain as “acmebank.com.” In some instances, if it is determined by the telecommunications security system that the phone number has no indication of legitimate domains, the telecommunications security system may rely on other techniques to determine the authenticity of the callback.

Further, based on the determined sending domain, the telecommunications security system may be configured to receive and/or extract a phone number associated with the sending domain from one or more sources. For example, phone numbers associated with sending domains may be aggregated and stored at a single location (e.g., a datastore). Such a datastore may be associated with a domain name system (DNS) (e.g., the email security system may query DNS records to extract and/or receive a phone number associated with the sending domain). The DNS may be provided by a third-party, internet service provider (ISP), and/or the like. In some instances, DNS records may include DNS TXT records, where the DNS TXT records include information provided by the owner of the sending domain. For example, DNS TXT records may include an indication of one or more phone numbers provided by an entity that is the owner of the sending domain. Phone numbers included in DNS TXT records may be those to be authenticated as legitimate and associated with the entity (e.g., phone numbers used by the entity when engaging in callbacks with customers). DNS records may also include digital certificates authenticating the DNS TXT records (e.g., Verified Mark Certificates (VMCs)). For example, DNS TXT records associated with the sending domain of “acmebank.com” may include an indication of phone numbers such as +1 (123) 456-7890 and +1 (999) 999-9999 that are legitimate callback phone numbers of the acmebank.com sending domain.

Once one or more phone numbers associated with the sending domain have been extracted and/or received by the telecommunications security system, the telecommunications security system may be configured to validate the phone number associated with the telecommunication. By way of example, and not limitation, the telecommunications security system may be configured to validate the phone number of an incoming callback communication of the receiving user and/or an attempted callback communication with the phone number by the receiving user by determining whether the phone number is included as part of the DNS TXT record associated with the sending domain. In other words, the telecommunications security system may compare the phone number included in the callback communication to the phone numbers associated with the sending domain to determine whether there is a match. In some instances, the telecommunications security system may be configured to determine whether there is an exact match between the phone number included in the email and the phone numbers included in the DNS TXT records of the sending domain. If there is a match, or association, between phone numbers and/or the phone number associated with the callback communication has been validated, the telecommunications security system may determine that the incoming and/or outcoming callback communication is associated with a legitimate callback attempt. Continuing from the example above, if the phone number of the callback communication is a phone number such as +1 (111) 111-1111, the telecommunications security system may determine that the phone number of the callback communication is not validated and/or potentially malicious. Additionally, or alternatively, if the phone number of the callback communication was a phone number such as +1 (123) 456-7890, the telecommunications security system may determine that the phone number is validated. In some instances, if there is no association and/or the phone number of the callback communication has not been validated, the telecommunications security system may determine that the callback communication is malicious. In some instances, if it is determined by the telecommunications security system that the sending domain has no indication of legitimate phone numbers (e.g., there is no phone number included in a DNS TXT record of the sending domain to be compared to the phone number of the callback communication), the telecommunications security system may rely on other techniques to determine the authenticity of the callback. Upon the determination of the validity the phone number of the callback communication, the telecommunications security system may be configured to classify the callback communication as a legitimate callback communication (e.g., when there is a match between phone numbers), or a malicious callback communication (e.g., associated with callback phishing).

Based on the classification of the callback communication (e.g., whether the callback communication is legitimate or malicious), the telecommunications security system may process the incoming and/or outgoing callback communication accordingly. For example, in instances where the callback communication is legitimate, the telecommunications security system may be configured to forward and/or transmit the callback communication of a receiving user such that a communication session may be established. In another example, in instances where the callback communication is malicious, the telecommunications security system may be configured to perform a remedial action with respect to the callback communication. Remedial actions may include dropping the callback communication, preventing further communication received from the sender and/or further communication sharing similarities with the phone number, domain name, etc., blocking and/or flagging the callback communication, reporting sender information and/or the phone number to authorities, notifying the receiving user via the user device of the callback communication, and/or the like.

The techniques described herein improve the function of email and telecommunications security systems. For example, while secure email gateways (SEGs) may monitor emails for malicious content and implement pre-delivery protection by blocking email-based threats before they reach a mail server, once the receiving user of a callback phishing email engages in a telephone call with a malicious sender, the telephone call is outside the scope of the SEG protection. Additionally, SEGs are unable to convict an incoming email as being associated with callback phishing due to a high false positive rate associated with callback phishing (e.g., an incoming email with a callback phone number may be associated with a genuine entity). However, there may be several instances where a genuine entity may wish to use callback techniques for legitimate purposes.

Accordingly, the techniques described herein may increase efficiencies around the detection and prevention of callback phishing attacks in emails, telecommunications, and/or other electronic communications, and thus preventing disastrous implications for individuals, enterprises, businesses, and/or the like (e.g., financial loss, emotional damage, etc.). Additionally, the determination and use of a phone number and/or sending domain may improve the utilization of computing resources, reduce the number of necessary VM instances to be spun up to determine email intent, and thus reduce customer costs.

Some of the techniques described herein are with reference to callback phishing emails and/or telecommunications. However, the techniques are generally applicable to any type of malicious email and/or telecommunications. Additionally, or alternatively, the techniques described herein are with reference to a network, such as a cloud provider network or platform, and networks such as VPCs, subnetworks (or “subnets”). However, the techniques are equally applicable to any network and in any environment. For example, the email and/or telecommunications security system may monitor an on-premises network.

Various implementations of the present disclosure will be described in detail with reference to the drawings, wherein like reference numerals present like parts and assemblies throughout the several views. Additionally, any samples set forth in this specification are not intended to be limiting and merely demonstrate some of the many possible implementations.

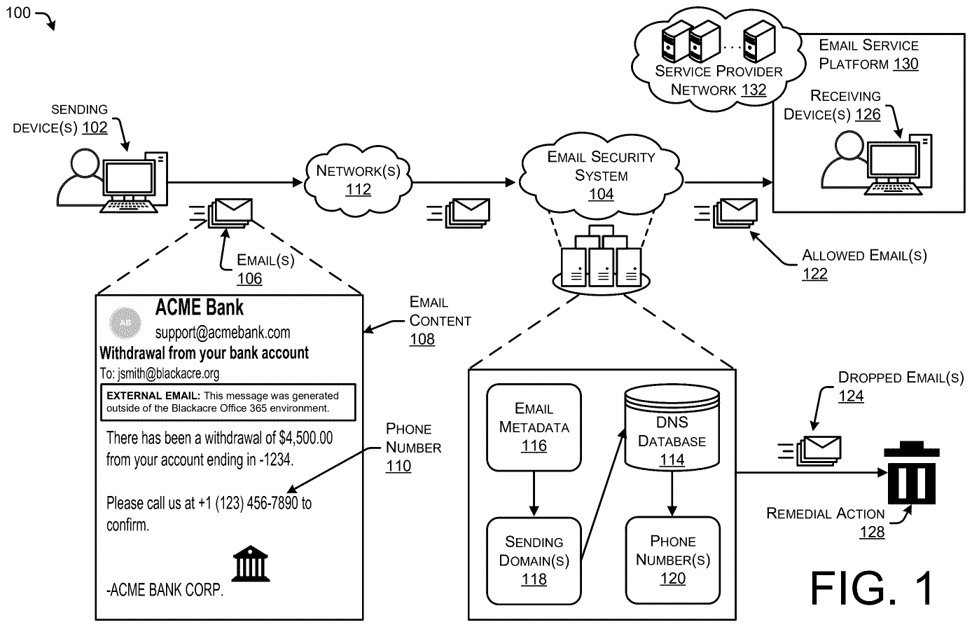

FIG. 1 illustrates an example environment 100 in which an email security system 104 validates a callback phone number 110 in incoming email 106, and processes the email accordingly.

In some examples, an email service platform 130 may be at a service provider network 132. The service provider network 132 may be or comprise a cloud provider network. A cloud provider network (sometimes referred to simply as a “cloud”) refers to a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to user commands. In other instances, however, the service provider network 132 may be an on-premises network, a private network of a corporation, and/or any other type of network or combination thereof.

Additionally, or alternatively, the email service platform 130 may use, or work in combination with, the email security system 104. The email security system 104 may be a scalable system that includes and/or runs on devices housed or located in one or more data centers, that may be located at different physical locations. In some examples, the email security system 104 may be included in the email service platform 130 and/or associated with a secure email gateway (SEG). The email security system 104 and the email service platform 130 may be supported by networks of devices in a public cloud computing platform, a private/enterprise computing platform, and/or any combination thereof. The one or more data centers may be physical facilities or buildings located across geographic areas that are designated to store network devices that are part of and/or support the email security system 104. The data centers may include various networking devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as process (CPU), memory (RAM), storage (disk), and networking (bandwidth).

The email security system 104 may be associated with the email service platform 130 of an email service provider, and may generally comprise any type of email and/or service provided by any provider, including public messaging service providers (e.g., Google Gmail, Microsoft Outlook, Yahoo! Mail, etc.), as well as private messaging service platforms maintained and/or operated by a private entity or enterprise. Further, the email service platform 130 may comprise cloud-based messaging service platforms (e.g., Google G Suite, Microsoft Office 365, etc.) that host messaging services. However, the email service platform 130 may generally comprise any type of platform for managing communication between clients or users, such as an email platform, a simple messaging service (SMS) platform, an audio/video communication platform, and so forth. The email service platform 130 may generally comprise a delivery engine behind email communications and include the requisite software and hardware for delivering email communications between users. For instance, an entity may operate and maintain the software and/or hardware of the email service platform 130 to allow users to send and receive emails, store and review emails in inboxes, manage and segment contact lists, build email templates, manage and modify inboxes and folders, scheduling, and/or any other operations performed using the email service platform 130.

The email service platform 130 may provide one or more messaging services to users of receiving device(s) 126 (or any type of user device) to enable the receiving device(s) 126 to communicate and/or receive emails. Sending device(s) 102 may communicate with receiving device(s) 126 over network(s) 112, such as the Internet. In some instances, the network(s) 112 may generally comprise one or more networks implemented by any viable communication technology, such as wired and/or wireless modalities and/or technologies. The network(s) 112 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The network(s) 112 may include devices, virtual resources, or other nodes that relay packets from one device to another.

User devices, such as the sending device(s) 102 that send emails 106 and the receiving device(s) 126 that receive the emails (e.g., allowed email 122), may comprise any type of electronic device capable of communicating using email communications. For instance, the devices 102/126 may include one or more of different personal user devices, such as desktop computers, laptop computers, phones, tablets, wearable devices, entertainment devices such as televisions, and/or any other type of computing device. Thus, the devices 102/126 may utilize the email service platform 130 to communicate using emails based on email address domain name systems according to techniques known in the art.

As illustrated, the email security system 104 (e.g., a SEG), may receive, or intercept, emails 106 and/or other types of electronic communications that are to be communicated to receiving device(s) 126 of an email service platform 130 from sending device(s) 102, such as being stored at a location that is accessible to the users via their respective inboxes. After receiving an email for a user (e.g., a receiving device(s) 126) of the email service platform 130, the email security system 104 may be configured to extract email metadata 116 associated with the emails 106. Email metadata 116 may include, for example, email content 108 such as indications of “From-Field” addresses and/or names for the email, “To-Field” addresses for the email, a “Subject” of the email, a Date/Time the email was communicated, hashes of attachments to the email, URLs in the body of the email, Internet Protocol (IP) addresses associated with the email, and/or a domain associated with the email (e.g., the email server associated with an email address). In some instances, the email metadata 116 may additionally, or alternatively, include content included in the body of the email, actual attachments to the email, and/or other data of the email. Further, the email metadata 116 extracted from the email 106 may generally be any probative information for the email security system 104 to determine a callback intent associated with the email 106.

The email security system 104 may be configured to determine a callback intent of an incoming email 106 based on the email metadata 116, and in turn, validate a callback phone number included in the email 106, such as phone number 110. The email metadata 116 may be processed using security analysis techniques to determine whether the email 106 is associated with a callback (e.g., the callback intent). For example, the email security system 104 may determine that the email 106 includes an indication of a phone number 110, with instructions requesting that the receiving user call the phone number to engage regarding the subject matter of the email (e.g., a callback attempt). The determination of the callback intent of the email may be represented as a general result (e.g., potentially a callback, not a callback, etc.) or a probability score indicative of a likelihood of a callback intent, and/or the like.

As described above, the email 106 received, or intercepted, by the email security system 104 may be designed to engage the receiving user in a callback. For instance, the email 106 may include a request for a confirmation of a delivery, a notification regarding a bank account transaction, a list of unpaid invoices, sensitive information, and/or the like. Further, the email 106 may include, along with the request, notification, etc., an indication of the phone number 110 for the user to engage with. As illustrated, the email metadata of email 106 may include phone number 110 and email content 108. The email content may include a notification that a certain amount of funds is going to be withdrawn from a user account, as well as phone number 110 (e.g., +1 (123) 456-7890) and instructions to call the phone number 110 if the withdrawal is in error. In some instances, the phone number 110 may be included within the body of the email 106, an attachment to the email, URLs included with the email, and/or the like.

Additionally, or alternatively, the email security system 104 may be configured to determine a phone number 120 associated with a sending domain 118 of the email 106. As described above, email metadata 116 may include an indication of a sending domain 118. For example, a sending domain 118 may include indications such as “acmebank.com” for a sending email address of “john@acmebank.com.” Based on the sending domain 118, the email security system 104 may be configured to receive and/or extract a phone number 120 associated with the sending domain 118 from one or more sources. For example, phone numbers 120 associated with sending domain 118 may be aggregated and stored at a single location (e.g., a datastore). Such a datastore may be associated with a domain name system (DNS) (e.g., the email security system 104 may query DNS records (e.g., DNS database 114) to extract and/or receive a phone number associated with the sending domain 118). The DNS database 114 may be provided by a third-party, internet service provider (ISP), and/or the like. In some instances, the DNS database 114 may include DNS TXT records, where the DNS TXT records include information provided by the owner of the sending domain 118. For example, DNS TXT records may include an indication of one or more phone numbers 120 provided by an entity that is the owner of the sending domain 118. Phone numbers 120 included in DNS TXT records of the DNS database 114 may be those to be authenticated as legitimate and associated with the entity (e.g., phone numbers used by the entity when engaging in callbacks with customers). The DNS database 114 may also include digital certificates authenticating the DNS TXT records and related digital certificates (e.g., Verified Mark Certificates (VMCs)).

Once one or more phone numbers 120 associated with the sending domain 118 have been extracted and/or received by the email security system 104, the email security system 104 may be configured to validate the phone number 110 included in the email 106. By way of example, and not limitation, the email security system 104 may be configured to validate the phone number 110 included in the email 106 by determining whether the phone number 110 is included as part of the DNS TXT record of DNS database 114 and associated with the sending domain 118. In other words, the email security system 104 may compare the phone number 110 included in the email 106 to the phone numbers 120 associated with the sending domain 118 to determine whether there is a match. In some instances, the email security system 104 may be configured to determine whether there is an exact match between the phone number included in the email and the phone numbers included in the DNS TXT records of the sending domain 118. If there is a match, or association, between phone numbers and/or the phone number 110 included in the email 106 has been validated, the email security system 104 may determine that the incoming email 106 is associated with a legitimate callback attempt. In some instances, if there is no association and/or the phone number 110 included in the email 106 has not been validated, the email security system 104 may determine that the incoming email 106 is malicious. In some instances, if it is determined by the email security system 104 that the sending domain 118 has no indication of legitimate phone numbers (e.g., there is no phone numbers 120 included in the DNS database and associated with the sending domain 118 to be compared to the phone number 110 included in the email 106), the email security system 104 may rely on other techniques to determine the authenticity of the email 106 (e.g., metadata associated with the email 106, reputation of the sending domain 118, etc.). Upon the determination of the validity the phone number 110 included in the email 106, the email security system 104 may be configured to classify the email 106 as a legitimate callback email (e.g., when there is a match between phone numbers) or a callback phishing attempt email.

Based on the classification of the email 106 (e.g., whether the email is a legitimate callback email or a callback phishing attempt email), the email security system 104 may process the incoming email 106 accordingly. For example, in instances where the email 106 is a legitimate callback email, the email security system 104 may be configured to forward and/or transmit the email 106 (e.g., as allowed email 122) to a receiving user such that the email allowed email 122 is delivered to the receiving user's inbox. In another example, in instances where the email 106 is a callback phishing attempt email, the email security system 104 may be configured to perform a remedial action 128 with respect to the callback phishing attempt email, such as dropping the email (e.g., as dropped email 124).

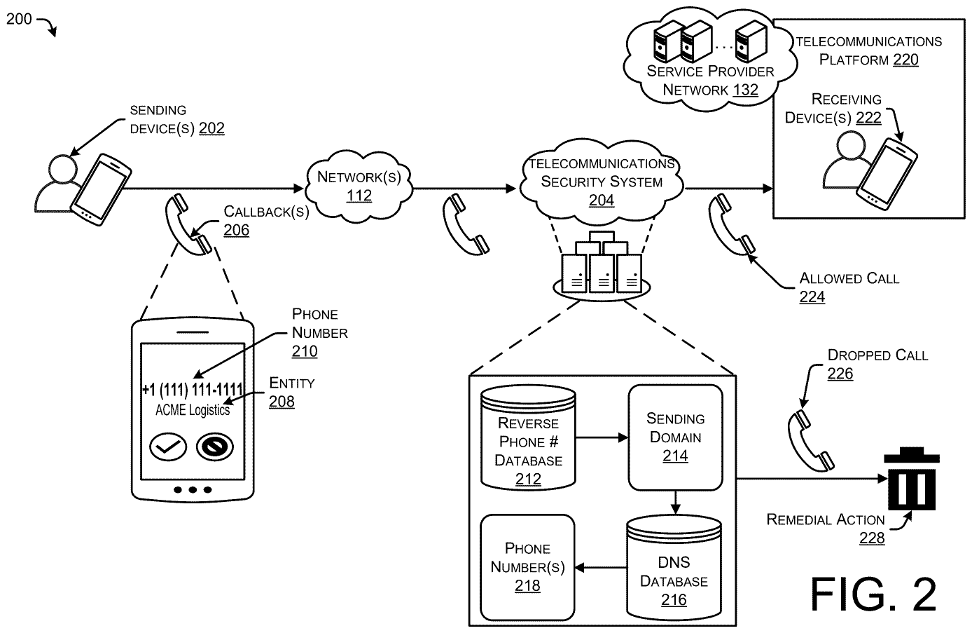

FIG. 2 illustrates an example environment 200 in which a telecommunications security system 204 validates a callback phone number in incoming and/or outgoing calls, and processes the calls accordingly.

In some examples, a telecommunications service platform 220 may be at a service provider network 132. The service provider network 132 may be or comprise a cloud provider network. A cloud provider network (sometimes referred to simply as a “cloud”) refers to a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to user commands. In other instances, however, the service provider network 132 may be an on-premises network, a private network of a corporation, and/or any other type of network or combination thereof.

Additionally, or alternatively, the telecommunications service platform 220 may use, or work in combination with, the telecommunications security system 204. The telecommunications security system 204 may be a scalable system that includes and/or runs on devices housed or located in one or more data centers, that may be located at different physical locations. In some examples, the telecommunications security system 204 may be included in the telecommunications service platform 220, associated with an application, and/or the like. The telecommunications security system 204 and the telecommunications service platform 220 may be supported by networks of devices in a public cloud computing platform, a private/enterprise computing platform, and/or any combination thereof. The one or more data centers may be physical facilities or buildings located across geographic areas that are designated to store network devices that are part of and/or support the telecommunications security system 204. The data centers may include various networking devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as process (CPU), memory (RAM), storage (disk), and networking (bandwidth).

The telecommunications security system 204 may be associated with the telecommunications service platform 220 of an telecommunications service provider, and may generally comprise any type of communications and/or service provided by any provider, including cellular-based telecommunications, internet-based communications (e.g., from providers such as Google Voice, WhatsApp, Mobile VoIP, etc.). Further, the telecommunications service platform 220 may comprise cloud-based telecommunications service platforms. However, the telecommunications service platform 220 may generally comprise any type of platform for managing communication between clients or users, such as a simple messaging service (SMS) platform, an audio/video communication platform, and so forth. The telecommunications service platform 220 may generally comprise a delivery engine behind telecommunications and include the requisite software and hardware for delivering telecommunications between users.

The telecommunications service platform 220 may provide one or more communication services to users of receiving device(s) 222 (or any type of user device) to enable the receiving device(s) 222 to communicate and/or receive telecommunications. Sending device(s) 202 may communicate with receiving device(s) 222 over network(s) 112, such as the Internet. In some instances, the network(s) 112 may generally comprise one or more networks implemented by any viable communication technology, such as wired and/or wireless modalities and/or technologies. The network(s) 112 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The network(s) 112 may include devices, virtual resources, or other nodes that relay packets from one device to another.

User devices, such as the sending device(s) 202 that send callbacks 206 and the receiving device(s) 222 that receive the callbacks 206 (e.g., allowed calls 224), may comprise any type of electronic device capable of telecommunications (e.g., configured as a computer telephone interface, uses a Voice over Internet Protocol (VoIP, etc.). For instance, the devices 202/222 may include one or more of different personal user devices, such as desktop computers, laptop computers, phones, tablets, wearable devices, entertainment devices such as televisions, and/or any other type of computing device.

To implement the techniques described herein, a telecommunications service platform 220 may use, or work in combination with, a telecommunications security system 204. The telecommunications security system 204 (e.g., an application on a user device, such as receiving device 222) may receive, or intercept, telecommunications and/or other types of communications that are to be communicated to and/or from users of the telecommunications service platform 220. A user of the telecommunications service platform 220 (e.g., user of the receiving device 222) may receive a callback 206 (e.g., returning phone call from call center, doctor's office, entity, etc. subsequent to an initial communication). For example, a receiving user may have previously engaged in an initial communication with an entity (e.g., a call center) and is receiving the callback 206 to avoid waiting on hold. While not illustrated in FIG. 2, a person of ordinary skill in the art would understand the techniques described herein may similarly be applied to instances where the receiving device 222 is initiating, or sending, the callback 206 and or attempt to engage in a telecommunication (e.g., the user of the receiving device 222 dials a callback phone number included in a received email). After receiving the callback 206, the telecommunications security system 204 may be configured to extract phone number metadata associated with the callback 206. Phone number metadata may include an indication of a phone number 210 (e.g., the phone number associated with the incoming callback 206), an indication of an entity 208 that is presented as being associated with the phone number, etc. Based on the phone number metadata, the telecommunications security system 204 may be configured to determine the phone number 210 associated with the callback 206.

Additionally, or alternatively, the telecommunications security system 204 may be configured to determine a sending domain 214 associated with the phone number 210. Based on the phone number 210, the telecommunications security system 204 may be configured to receive and/or extract a sending domain 214 associated with the phone number 210 from one or more sources. For example, sending domains 214 associated with phone numbers may be aggregated and stored at a single location (e.g., a datastore). Such a datastore may be associated with a DNS (e.g., using a reverse-DNS look-up), a reverse phone number database 212 (e.g., provided by a third-party, ISP, etc.). The telecommunications security system 204 may query, or perform a reverse look-up, such that a sending domain 214 may be determined based on the phone number 210 of the callback 206 and from the reverse phone number database 212. For example, based on a phone number of +1 (111) 111-1111 associated with the callback 206 of the receiving user, the telecommunications security system 204 may identify the sending domain 214 as “acmebank.com.”

Further, based on the determined sending domain 214, the telecommunications security system 204 may be configured to receive and/or extract a phone number 218 associated with the sending domain 214 from one or more sources. For example, phone numbers associated with sending domains 214 may be aggregated and stored at a single location (e.g., a datastore). Such a datastore may be associated with a domain name system (DNS) (e.g., the telecommunications security system 204 may query DNS database 216, which may correspond to DNS database 114) to extract and/or receive a phone number 218 associated with the sending domain 214). The DNS database 216 may be provided by a third-party, internet service provider (ISP), and/or the like. In some instances, the DNS database 216 may include DNS TXT records, where the DNS TXT records include information provided by the owner of the sending domain 214. For example, DNS TXT records may include an indication of one or more phone numbers provided by an entity, such as entity 208, that is the owner of the sending domain 214. Phone numbers included in DNS TXT records may be those to be authenticated as legitimate and associated with the entity, such as entity 208 (e.g., phone numbers used by the entity when engaging in callbacks with customers). The DNS database may also include digital certificates authenticating the DNS TXT records (e.g., Verified Mark Certificates (VMCs)).

Once one or more phone numbers 218 associated with the sending domain 214 have been extracted and/or received by the telecommunications security system 204, the telecommunications security system 204 may be configured to validate the phone number 210 associated with the callback 206. By way of example, and not limitation, the telecommunications security system 204 may be configured to validate the phone number 210 of an incoming callback 206 of the receiving user by determining whether the phone number 210 is included as part of the DNS TXT record associated with the sending domain 214, as indicated in the DNS database 216. In other words, the telecommunications security system 204 may compare the phone number 210 included in the callback 206 to the phone numbers 218 associated with the sending domain 214 to determine whether there is a match. If there is a match, or association, between phone numbers and/or the phone number 210 associated with the callback 206 has been validated, the telecommunications security system 204 may determine that the callback 206 is associated with a legitimate callback attempt. In some instances, if there is no association and/or the phone number 210 of the callback 206 has not been validated, the telecommunications security system 204 may determine that the callback 206 is malicious. Upon the determination of the validity the phone number of the callback 206, the telecommunications security system 204 may be configured to classify the callback 206 as a legitimate callback 206 (e.g., when there is a match between phone numbers), or a malicious callback 206 (e.g., associated with callback phishing).

Based on the classification of the callback 206 (e.g., whether the callback 206 is legitimate or malicious), the telecommunications security system 204 may process the callback 206 accordingly. For example, in instances where the callback 206 is legitimate, the telecommunications security system 204 may be configured to forward and/or transmit the callback 206 of a receiving user of receiving device 222 such that a communication session may be established (e.g., as allowed call 224). In another example, in instances where the callback 206 is malicious, the telecommunications security system 204 may be configured to perform a remedial action 228 with respect to the callback 206. Remedial actions 228 may include dropping the callback 206 (e.g., as dropped call 226), preventing further communication received from the sending device 202 and/or further communication sharing similarities with the phone number 210, sending domain 214, etc., blocking and/or flagging the callback 206, reporting sender information and/or the phone number 210 to authorities, notifying the receiving user via the receiving device 222 of the callback 206, and/or the like.

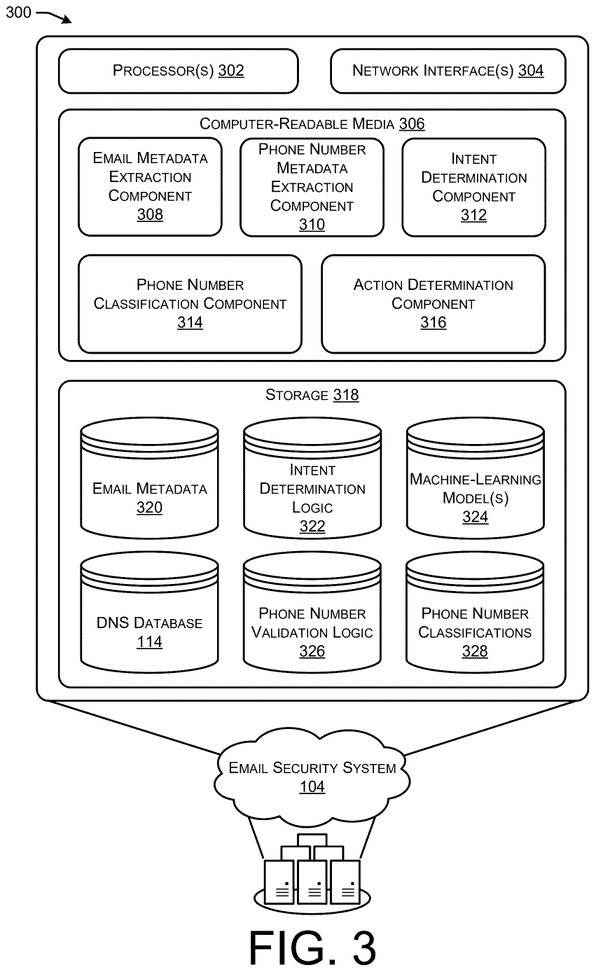

FIG. 3 illustrates a component diagram 300 of an example email security system 104 that uses email intent and phone number reputation to detect a callback phishing attempt included in an email. As illustrated, the email security system 104 may include one or more hardware processors 302 (processors), one or more devices, configured to execute one or more stored instructions. The processor(s) 302 may comprise one or more cores. Further, the email security system 104 may include one or more network interfaces 304 configured to provide communications between the email security system 104 and other devices, such as the sending device(s) 102, receiving device(s) 126, and/or other systems or devices associated with an email service providing the email communications. The network interfaces 304 may include devices configured to couple to personal area networks (PANs), wired and wireless local area networks (LANs), wired and wireless wide area networks (WANs), and so forth. For example, the network interfaces 304 may include devices compatible with Ethernet, Wi-Fi™, and so forth.

The email security system 104 may also include computer-readable media 306 that stores various executable components (e.g., software-based components, firmware-based components, etc.). The computer-readable media 306 may store components to implement functionality described herein. While not illustrated, the computer-readable media 306 may store one or more operating systems utilized to control the operation of the one or more devices that comprise the email security system 104. According to one instance, the operating system comprises the LINUX operating system. According to another instance, the operating system(s) comprise the WINDOWS® SERVER operating system from MICROSOFT Corporation of Redmond, Washington. According to further embodiments, the operating system(s) can comprise the UNIX operating system or one of its variants. It should be appreciated that other operating systems can also be utilized.

The computer-readable media 306 may include portions, or components, that configure the email security system 104 to perform various operations described herein. For example, an email metadata extraction component 308 may be configured to, when executed by the processor(s) 302, perform various techniques for extracting email metadata (e.g., email information used to determine a callback intent and validate the callback phone number). Email metadata may include, for example, indications of email content such as “From-Field” addresses and/or names for the email, “To-Field” addresses for the email, a “Subject” of the email, a Date/Time the email was communicated, hashes of attachments to the email, URLs in the body of the email, IP addresses associated with the email, and/or a domain associated with the email. In some instances, the metadata may additionally, or alternatively, include content included in the body of the email, actual attachments, and/or the like.

The computer-readable media 306 may further include a phone number metadata extraction component 310 that may configure the email security system 104 to perform various operations described herein. For instance, the phone number metadata extraction component 310 may be configured to, when executed by the processor(s) 302, perform various techniques for extracting and/or receiving metadata associated with a phone number included in an email (e.g., a callback phone number included in the content of the email and associated with a callback intent).

The computer-readable media 306 may further include an intent determination component 312 that may configure the email security system 104 to perform various operations described herein. For instance, the intent determination component 312 may be configured to, when executed by the processor(s) 302, perform various techniques for analyzing email metadata to determine an email intent, such as whether the email intent includes a callback intent. The intent determination component 312 may utilize policies and/or rules to analyze email metadata to determine if the corresponding email includes a callback intent.

The computer-readable media 306 may further include phone number classification component 314 that may configure the email security system 104 to perform various operations described herein. For instance, the phone number classification component 314 may be configured to, when executed by the processor(s) 302, perform various techniques for determining whether an incoming email is associated with a callback phishing attempt or a legitimate use of a callback (e.g., by validating the phone number). For example, the phone number classification component 314 may utilize policies and/or rules to analyze the phone number metadata and DNS database 114 to classify a phone number as being associated with a phishing attempt or a legitimate callback.

The computer-readable media 306 may further include action determination component 316 that may configure the email security system 104 to perform various operations described herein. For instance, the action determination component 316 may be configured to, when executed by the processor(s) 302, perform various techniques for determining a remedial action associated with an incoming email, or whether to transmit the email to the receiving user. For example, the action determination component 316 may utilize policies and/or rules to determine a remedial action based at least in part on an email being classified as a callback phishing attempt. Additionally, or alternatively, the action determination component 316 may utilize policies and/or rules to determine to transmit, or forward, an incoming email to a receiving user based at least in part on the email being classified as including a legitimate callback.

The above-noted list of components and their respective processes are merely exemplary, and other types of security policies may be used to analyze the email and/or phone number metadata.

Additionally, the email security system 104 may include storage 318 which may comprise one, or multiple, repositories or other storage locations for persistently storing and managing collections of data such as databases, simple files, binary, and/or any other data. The storage 318 may include one or more storage locations that may be managed by one or more storage/database management systems.

As illustrated, the storage 318 may include email metadata 320, intent determination logic 322, ML model(s) 324, DNS database 114, phone number validation logic 326, and phone number classifications 328. It should be appreciated that the foregoing list is merely exemplary and the storage 318 may include additional elements that may be apparent to one skilled in the art.

The email metadata 320 may include a database of email metadata (e.g., metadata indicating the content, attributes, and/or other information associated with an email). Email metadata may include, for example, indications of “From-Field” addresses and/or names for the email, “To-Field” addresses for the email, a “Subject” of the email, a Date/Time the email was communicated, hashes of attachments to the email, URLs in the body of the email, Internet Protocol (IP) addresses associated with the email, and/or a domain associated with the email (e.g., the email server associated with an email address). In some instances, the metadata may additionally, or alternatively, include content included in the body of the email, actual attachments to the email, and/or other data of the email. Further, the metadata extracted from the email may generally be any probative information for the email security system to determine whether the email is associated with a callback intent and/or whether the phone number included in the email is a legitimate callback phone number. Additionally, or alternatively, the email metadata 320 may be a database of historically received and/or extracted email metadata.

The intent determination logic 322 may include a database of logic for determining an intent associated with an email (e.g., a callback intent). For example, the intent determination component 312 may reference intent determination logic 322 and/or email metadata 320 in determining whether there is a callback intent associated with an email.

The ML model(s) 324 may include a database of machine learning algorithms. The ML model(s) may include one or more algorithms including supervised, semi-supervised, unsupervised, and/or reinforcement. In some examples, the processor(s) 302 train(s) the email security system 104 utilizing machine learning techniques, statistical analysis, or any other means by which a system may be trained to output a detection of a callback intent and/or a validation of a callback phone number and/or other data associated with the storage 318.

The DNS database 114 may include a database of DNS records and for determining whether a phone number of an email associated with a callback intent is a validated email. For example, the DNS database 114 may include DNS TXT records, where the DNS TXT records include information provided by the owner of the sending domain. For example, DNS TXT records may include an indication of one or more phone numbers provided by an entity that is the owner of the sending domain.

The phone number validation logic 326 may include a database of logic for determining whether a phone number included in an email associated with a callback intent is a validated email (e.g., whether the phone number matches a phone number associated with the sending domain of the email and indicated by DNS TXT records). For example, the phone number classification component 314 may reference DNS database 114, email metadata 320, and/or DNS database 114 in determining whether a phone number is validated (e.g., whether the phone number of the email matches one or more phone numbers of the sending domain in the DNS database 114).

The phone number classifications 328 may store the results from the phone number classification component 314, the intent determination component 312, etc. For example, the phone number classifications 328 may be a database of historically classified phone numbers (e.g., whether the phone number is classified as a callback phishing attempt or a legitimate callback phone number). As such, the phone number classifications 328 may be used by the phone number classification component 314 during its operation (e.g., in determining subsequent phone number classifications) and/or the action determination component 316 during its operation (e.g., in determining an action to perform with respect to a classified phone number).

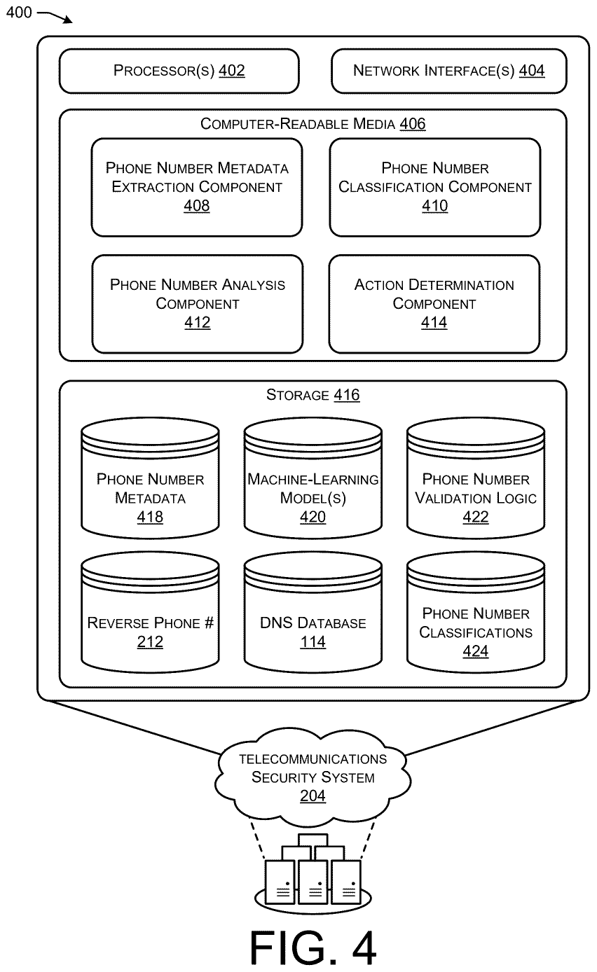

FIG. 4 illustrates a component diagram 400 of an example telecommunications security system 204 that uses email intent and phone number reputation to detect a callback phishing attempt included in an email. As illustrated, the telecommunications security system 204 may include one or more hardware processors 402 (processors), one or more devices, configured to execute one or more stored instructions. The processor(s) 402 may comprise one or more cores. Further, the telecommunications security system 204 may include one or more network interfaces 404 configured to provide communications between the telecommunications security system 204 and other devices, such as the sending device(s) 202, receiving devices 222, and/or other systems or devices associated with an email service providing the email communications. The network interfaces 404 may include devices configured to couple to personal area networks (PANs), wired and wireless local area networks (LANs), wired and wireless wide area networks (WANs), and so forth. For example, the network interfaces 404 may include devices compatible with Ethernet, Wi-Fi™, and so forth.

The telecommunications security system 204 may also include computer-readable media 406 that stores various executable components (e.g., software-based components, firmware-based components, etc.). The computer-readable media 406 may store components to implement functionality described herein. While not illustrated, the computer-readable media 406 may store one or more operating systems utilized to control the operation of the one or more devices that comprise the telecommunications security system 204. According to one instance, the operating system comprises the LINUX operating system. According to another instance, the operating system(s) comprise the WINDOWS® SERVER operating system from MICROSOFT Corporation of Redmond, Washington. According to further embodiments, the operating system(s) can comprise the UNIX operating system or one of its variants. It should be appreciated that other operating systems can also be utilized.

The computer-readable media 406 may include portions, or components, that configure the telecommunications security system 204 to perform various operations described herein. For example, a phone number metadata extraction component 408 may be configured to, when executed by the processor(s) 402, perform various techniques for extracting phone number metadata (e.g., phone number information used to determine a sending domain associated with the phone number). Phone number metadata may include an indication of a phone number (e.g., the phone number being dialed by the receiving user, the phone number associated with the incoming callback communication to the user, etc.), an indication of an entity that is presented as being associated with the phone number, etc. Based on the phone number metadata, the telecommunications security system may be configured to determine a phone number associated with the callback communication.

The computer-readable media 406 may further include a phone number analysis component 412 that may configure the telecommunications security system 204 to perform various operations described herein. For instance, the phone number analysis component 412 may be configured to, when executed by the processor(s) 402, perform various techniques for determining a sending domain associated with a phone number of a callback communication, and/or determine the phone number indicated as being associated with the sending domain from one or more sources (e.g., reverse phone number database 212, DNS database 114, etc.).

The computer-readable media 406 may further include phone number classification component 410 that may configure the telecommunications security system 204 to perform various operations described herein. For instance, the phone number classification component 410 may be configured to, when executed by the processor(s) 402, perform various techniques for determining whether an incoming and/or outgoing telecommunication is associated with a legitimate callback phone number, or a callback phishing attempt (e.g., by validating the phone number). For example, the phone number classification component 410 may utilize policies and/or rules to analyze the phone number metadata 418, reverse phone number database 212, and DNS database 114 to classify a phone number as being associated with a phishing attempt or a legitimate callback.

The computer-readable media 406 may further include action determination component 414 that may configure the telecommunications security system 204 to perform various operations described herein. For instance, the action determination component 414 may be configured to, when executed by the processor(s) 402, perform various techniques for determining a remedial action associated with a telecommunication. For example, the action determination component 414 may utilize policies and/or rules to determine a remedial action based at least in part on a phone number of a telecommunication being classified as a callback phishing attempt. Additionally, or alternatively, the action determination component 414 may utilize policies and/or rules to determine to transmit, or forward, an incoming email to a receiving user based at least in part on the email being classified as including a legitimate callback.

The above-noted list of components and their respective processes are merely exemplary, and other types of security policies may be used to analyze the phone number metadata.

Additionally, the telecommunications security system 204 may include storage 416 which may comprise one, or multiple, repositories or other storage locations for persistently storing and managing collections of data such as databases, simple files, binary, and/or any other data. The storage 416 may include one or more storage locations that may be managed by one or more storage/database management systems.

As illustrated, the storage 416 may include phone number metadata 418, ML model(s) 420, phone number validation logic 422, reverse phone number database 212, DNS database 114, and/or phone number classifications 424. It should be appreciated that the foregoing list is merely exemplary and the storage 416 may include additional elements that may be apparent to one skilled in the art.

The phone number metadata 418 may include a database of phone number metadata. Phone number metadata may include an indication of a phone number (e.g., the phone number being dialed by the receiving user, the phone number associated with the incoming callback communication to the user, etc.), an indication of an entity that is presented as being associated with the phone number, etc. Based on the phone number metadata, the telecommunications security system may be configured to determine a phone number associated with the callback communication. Further, the phone number metadata may generally be any probative information for the telecommunications security system to determine whether a telecommunication and associated phone number is a legitimate callback or a callback phishing attempt. Additionally, or alternatively, the phone number metadata 418 may be a database of historically received and/or extracted phone number metadata.

The ML model(s) 420 may include a database of machine learning algorithms. The ML model(s) may include one or more algorithms including supervised, semi-supervised, unsupervised, and/or reinforcement. In some examples, the processor(s) 402 train(s) the telecommunications security system 204 utilizing machine learning techniques, statistical analysis, or any other means by which a system may be trained to output a determination of a sending domain associated with the phone number of the telecommunication, a determination of a match between the phone number associated with the sending domain and the phone number of the telecommunication (e.g. whether the phone number of the telecommunication is validated), and/or other data associated with the storage 416.

The phone number validation logic 422 may include a database of logic for determining whether a phone number of a telecommunication is associated with a legitimate callback or a callback phishing attempt. For example, the phone number analysis component 412 and/or phone number classification component 410 may reference phone number validation logic 422, phone number metadata 418, reverse phone number database 212, and/or DNS database 114 in determining whether a phone number of a telecommunication is validated, and/or whether the phone number is associated with a legitimate callback or a callback phishing attempt (e.g., whether the phone number of the telecommunication matches one or more phone numbers of the determined sending domain in the DNS database 114).

The reverse phone number database 212 may include a database of phone number records and for determining a sending domain associated with the phone number of a telecommunication. The DNS database 114 may include a database of DNS records and for determining whether a phone number of telecommunication is validated. For example, the DNS database 114 may include DNS TXT records, where the DNS TXT records include information provided by the owner of a sending domain. For example, DNS TXT records may include an indication of one or more phone numbers provided by an entity that is the owner of the sending domain.

The phone number classifications 424 may store the results from the phone number analysis component 412, phone number classification component 410, etc. For example, the phone number classifications 424 may be a database of historically classified phone numbers (e.g., whether the phone number is classified as a callback phishing attempt or a legitimate callback phone number). As such, the phone number classifications 424 may be used by the phone number classification component 410 during its operation (e.g., in determining subsequent phone number classifications) and/or the action determination component 414 during its operation (e.g., in determining an action to perform with respect to a classified phone number).

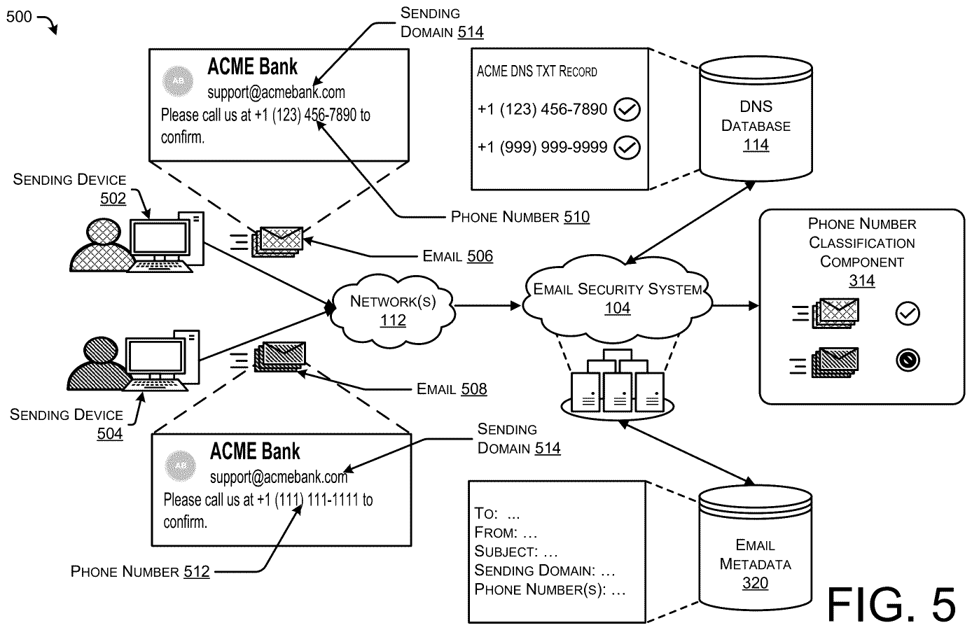

FIG. 5 illustrates a flow diagram of an example process 500 for using email metadata to validate a callback phone number included in an email.

As illustrated, sending devices, such as sending device 502 and/or sending device 504, may send an email, such as email 506 and/or email 508, via network(s) 112 to be delivered to a receiving user. The email security system 104 may receive, or intercept, email 506 and/or email 508, and may be configured to extract email metadata 320 associated with the email 506 and/or email 508. Email metadata 320 may include, for example, indications of “To-Field” addresses for the email, “From-Field” addresses for the email, a “Subject” of the email, a sender domain, URLs in the body of the email, hashes of attachments to the email, and/or the like. As illustrated, the email metadata 320 associated with email 506 may include phone number 510 and/or domain 514. The email metadata 320 associated with email 508 may include phone number 512 and/or domain 514. The email security system 104 may determine a callback intent associated with email 506 and/or email 508 (e.g., using intent determination component 312) based on the email metadata 320. For example, the email security system 104 may determine a callback intent associated with both email 506 and email 508 based on email metadata 320 such as the content of the email indicating instructions for a callback (e.g., “Please call us at . . . ”).

As illustrated, both email 506 and email 508 may appear to be from the receiving user's bank, along with a phone number to callback for confirmation. For example, email 506 may contain the phone number 510 of +1 (123) 456-7890. Email 508 may contain the phone number 512 of +1 (111) 111-1111. In some instances, the phone number may be included within the body of the email, an attachment to the email, URLs included with the email, and/or the like. While emails 506 and 508 are illustrated as including phone numbers with a North American Numbering Plan (NANP) (e.g., three-digit area code, seven-digit subscriber number, etc.), other conventions and/or formats for phone numbers may be used (e.g., 01 11 11 11 11, +12 3456 789101, etc.).

Additionally, or alternatively, the email security system 104 may be configured to, using email metadata 320, determine sending domain 514 associated with email 506 and/or email 508. For example, and as illustrated, both email 506 and email 508 may be associated with the sending domain 514 of “acme-bnk-corp.com.” Based on the sending domain 514, the email security system may be configured to determine a phone number associated with the sending domain 514. For example, phone numbers associated with sending domains may be aggregated and stored at a single location (e.g., a datastore). Such a datastore may be associated with a domain name system (DNS) (e.g., the email security system may query DNS records to extract and/or receive a phone number associated with the sending domain). In some instances, DNS records may include DNS TXT records, where the DNS TXT records include information provided by the owner of the sending domain. For example, and as illustrated, the sending domain 514 may include DNS TXT records in DNS database 114 indicating the phone numbers of +1 (123) 456-7890 and +1 (999) 999-9999. The phone numbers may be provided by the entity associated with, or owning, the sending domain 514 (e.g., ACME), such that the entity may indicate the phone numbers used in the legitimate use of callbacks. DNS database 114 may also include digital certificates authenticating the DNS TXT records (e.g., Verified Mark Certificates (VMCs)).

Once one or more phone numbers associated with the sending domain 514 have been extracted and/or received by the email security system 104, the email security system 104 may be configured to validate phone number 510 of email 506 and phone number 512 of email 508. For example, the email security system 104 may determine that the phone number 510 is included in the DNS database 114 and associated with the sending domain 514. The email security system 104 may determine that the phone number 512 is not included in the DNS database 114, and thus not associated with the sending domain 514. In other words, the email security system 104 determines a match between phone number 510 and the phone numbers indicated in the DNS database 114, but determines no match between the phone number 512 and the phone numbers indicated in the DNS database 114. Accordingly, phone number 510 is validated.

If there is a match, or association, between phone numbers and/or the phone number included in the email has been validated, the email security system may determine that the incoming email is associated with a legitimate callback attempt. For example, upon the determination of the validity of phone number 510, the email security system 104 may use, or work in combination with, the phone number classification component 314 to classify the phone number 510 and email 506 as a legitimate callback attempt. The email security system 104 may use, or work in combination with, the phone number classification component 314 to classify the phone number 512 and email 508 as potentially malicious (e.g., a callback phishing attempt).

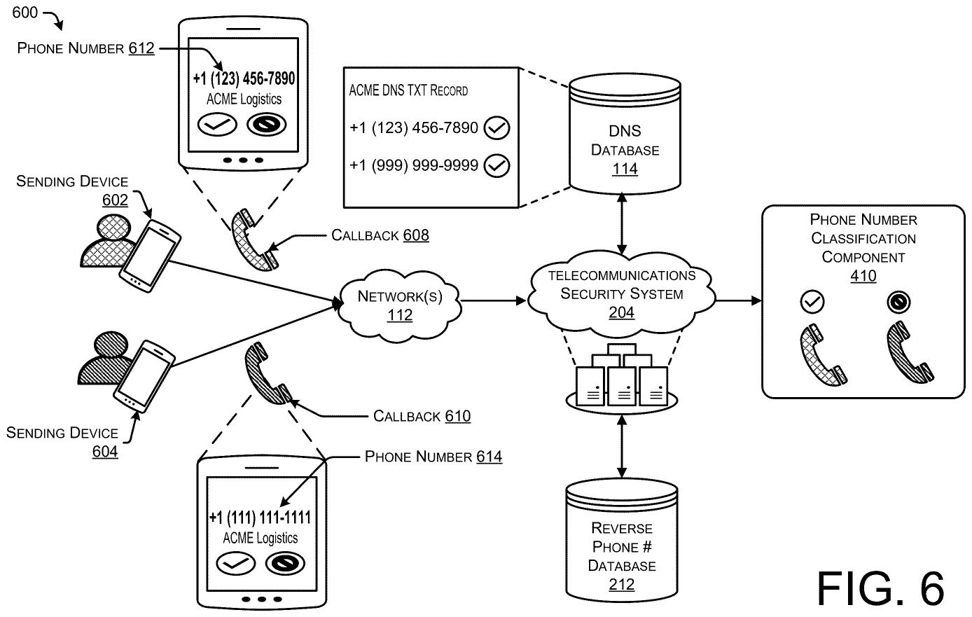

FIG. 6 illustrates a flow diagram of an example process 600 for using a callback phone number to retrieve DNS records and validate the callback phone number.

As illustrated, sending devices, such as sending device 602 and/or sending device 604, may attempt a callback, such as callback 608 and/or callback 610. The telecommunications security system 204 may receive, or intercept, callback 608 and/or callback 610, and may be configured to extract phone number metadata associated with the callback 608 and/or callback 610. Phone number metadata may include an indication of a phone number (e.g., the phone number being dialed by the receiving user, the phone number associated with the incoming callback communication to the user, etc.), an indication of an entity that is presented as being associated with the phone number, etc. Based on the phone number metadata, the telecommunications security system may be configured to determine a phone number associated with the callback communication.

As illustrated, both callback 608 and callback 610 may appear to be from the entity “ACME Logistics,” along with a phone number. For example, callback 608 may be associated with a phone number 612 of +1 (123) 456-7890. Callback 610 may be associated with phone number 614 of +1 (111) 111-1111. While callback 608 and callback 610 are illustrated as including phone numbers with a North American Numbering Plan (NANP) (e.g., three-digit area code, seven-digit subscriber number, etc.), other conventions and/or formats for phone numbers may be used (e.g., 01 11 11 11 11, +12 3456 789101, etc.).

Additionally, or alternatively, the telecommunications security system 204 may be configured to, using phone number 612 and/or phone number 614, determine a sending domain. For example, sending domains associated with phone numbers may be aggregated and stored at a single location (e.g., a datastore). Such a datastore may be associated with a DNS (e.g., using a reverse-DNS look-up), a reverse phone number database (e.g., provided by a third-party, ISP, etc.). The telecommunications security system may query, or perform a reverse look-up using reverse phone number database 212, such that a sending domain may be determined based on the phone number of the callback. For example, based on the phone number 612 of +1 (123) 456-7890 and the reverse phone number database 212, the telecommunications security system 204 may identify a sending domain such as “acmelogistics.com.” Additionally, or alternatively, based on the phone number 614 of +1 (111) 111-1111 and the reverse phone number database 212, the telecommunications security system 204 may identify the same sending domain (e.g., acmelogistics.com).

Once the sending domain has been determined by the telecommunications security system 204, the telecommunications security system may further determine the one or more phone numbers associated with the determined sending domain. For example, the telecommunications security system may query DNS database 114 to extract and/or receive a phone number associated with the sending domain. In some instances, DNS database 114 may include DNS TXT records, where the DNS TXT records include information provided by the owner of the sending domain. For example, and as illustrated, the sending domain may include DNS TXT records in DNS database 114 indicating the phone numbers of +1 (123) 456-7890 and +1 (999) 999-9999. The phone numbers may be provided by the entity associated with, or owning, the sending domain (e.g., ACME), such that the entity may indicate the phone numbers used in the legitimate use of callbacks. DNS database 114 may also include digital certificates authenticating the DNS TXT records (e.g., Verified Mark Certificates (VMCs)).

Once one or more phone numbers associated with the sending domain have been extracted and/or received by telecommunications security system 204, the telecommunications security system 204 may be configured to validate phone number 612 of callback 608 and phone number 614 of callback 610. For example, the telecommunications security system 204 may determine that the phone number 612 is included in the DNS database 114 and associated with the determined sending domain. The telecommunications security system 204 may determine that the phone number 614 is not included in the DNS database 114, and thus not associated with the determined sending domain. In other words, the telecommunications security system 204 determines a match between phone number 612 and the phone numbers indicated in the DNS database 114, but determines no match between the phone number 614 and the phone numbers indicated in the DNS database 114. Accordingly, phone number 612 is validated.

If there is a match, or association, between phone numbers and/or the phone number of the callback has been validated, the telecommunications security system 204 may determine that telecommunications, such as callback 608, is associated with a legitimate callback attempt. For example, upon the determination of the validity of phone number 612, the telecommunications security system 204 may use, or work in combination with, the phone number classification component 410 to classify the phone number 612 and callback 608 as a legitimate callback attempt. The telecommunications security system 204 may use, or work in combination with, the phone number classification component 410 to classify the phone number 614 and callback 610 as malicious (e.g., a callback phishing attempt).

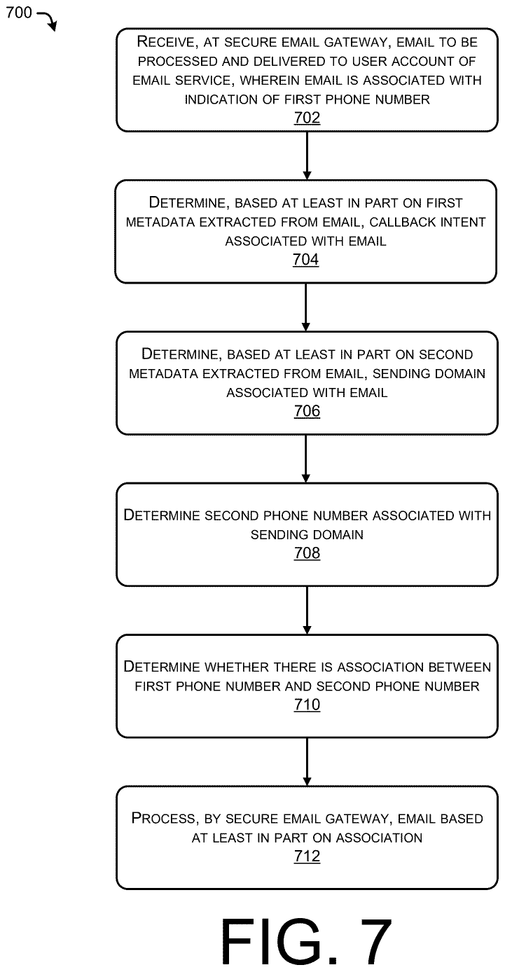

FIG. 7 illustrates a flow diagram of an example process 700 for process for enabling and preventing callback phishing in incoming emails. The techniques may be applied by a system comprising one or more processors, and one or more non-transitory computer-readable media storing computer-executable instructions that, when executed by the one or more processors, cause the one or more processors to perform operations of process 700.

The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, although the processes may be implemented in a wide variety of other environments, architectures and systems.

At block 702, the process may include receiving, at a secure email gateway, an email to be processed and delivered to a user account of an email service, wherein the email is associated with an indication of a first phone number. For example, an email service platform may use, or work in combination with, an email security system. The email security system (e.g., a SEG), may receive, or intercept, emails and/or other types of electronic communications that are to be communicated to users of the email service platform, such as being stored at a location that is accessible to the users via their respective inboxes. After receiving an email for a user (e.g., a receiving user) of the email service platform, the email security system may be configured to extract email metadata associated with the email. Email metadata may include, for example, indications of “From-Field” addresses and/or names for the email, “To-Field” addresses for the email, a “Subject” of the email, a Date/Time the email was communicated, hashes of attachments to the email, URLs in the body of the email, Internet Protocol (IP) addresses associated with the email, and/or a domain associated with the email (e.g., the email server associated with an email address). In some instances, the metadata may additionally, or alternatively, include content included in the body of the email, actual attachments to the email, and/or other data of the email. Further, the metadata extracted from the email may generally be any probative information for the email security system to determine a callback intent associated with the email.

At block 704, the process may include determining, based at least in part on first metadata extracted from the email, a callback intent associated with the email. For example, the email security system may be configured to determine a callback intent of an incoming email based on the email metadata, and in turn, validate a callback phone number included in the email. The email metadata may be processed using security analysis techniques to determine whether the email is associated with a callback (e.g., the callback intent). For example, the email security system may determine that the email includes an indication of a phone number, with instructions requesting that the receiving user call the phone number to engage regarding the subject matter of the email (e.g., a callback attempt). The determination of the callback intent of the email may be represented as a general result (e.g., potentially a callback, not a callback, etc.) or a probability score indicative of a likelihood of a callback intent, and/or the like.

As described above, the email received, or intercepted, by the email security system may be designed to engage the receiving user in a callback. For instance, the email may include a request for a confirmation of a delivery, a notification regarding a bank account transaction, a list of unpaid invoices, sensitive information, and/or the like. Further, the email may include, along with the request, notification, etc., an indication of the phone number for the user to engage with. For example, the email may appear to be from the receiving user's bank, include a notification that a certain amount of funds is going to be withdrawn from a user account, as well as a phone number to call if the withdrawal is an error. In some instances, the phone number may be included within the body of the email, an attachment to the email, URLs included with the email, and/or the like.

At block 706, the process may include determining, based at least in part on second metadata extracted from the email, a sending domain associated with the email. As described above, email metadata may include an indication of a sending domain. For example, a sending domain may include indications such as “acmebank.com” for a sending email address of “john@acmebank.com.”

At block 708, the process may include determining, a second phone number associated with the sending domain. For example, based on the sending domain, the email security system may be configured to receive and/or extract a phone number associated with the sending domain from one or more sources. For example, phone numbers associated with sending domains may be aggregated and stored at a single location (e.g., a datastore). Such a datastore may be associated with a domain name system (DNS) (e.g., the email security system may query DNS records to extract and/or receive a phone number associated with the sending domain). The DNS may be provided by a third-party, internet service provider (ISP), and/or the like. In some instances, DNS records may include DNS TXT records, where the DNS TXT records include information provided by the owner of the sending domain. For example, DNS TXT records may include an indication of one or more phone numbers provided by an entity that is the owner of the sending domain. Phone numbers included in DNS TXT records may be those to be authenticated as legitimate and associated with the entity (e.g., phone numbers used by the entity when engaging in callbacks with customers). DNS records may also include digital certificates authenticating the DNS TXT records (e.g., Verified Mark Certificates (VMCs)). For example, DNS TXT records associated with the sending domain of “acmebank.com” may include an indication of phone numbers such as +1 (123) 456-7890 and +1 (999) 999-9999 that are legitimate callback phone numbers of the acmebank.com sending domain.

At block 710, the process may include determining whether there is an association between the first phone number and the second phone number. For example, once one or more phone numbers associated with the sending domain have been extracted and/or received by the email security system, the email security system may be configured to validate the phone number included in the email. By way of example, and not limitation, the email security system may be configured to validate the phone number included in the email by determining whether the phone number is included as part of the DNS TXT record associated with the sending domain. In other words, the email security system may compare the phone number included in the email to the phone numbers associated with the sending domain to determine whether there is a match. In some instances, the email security system may be configured to determine whether there is an exact match between the phone number included in the email and the phone numbers included in the DNS TXT records of the sending domain. If there is a match, or association, between phone numbers and/or the phone number included in the email has been validated, the email security system may determine that the incoming email is associated with a legitimate callback attempt. Continuing from the example above, if the email from the sending domain of acnmebank.com includes an indication of a phone number such as +1 (999) 999-9990, the email security system may determine that the phone number included in the email is not validated and/or potentially malicious. Additionally, or alternatively, if the email includes an indication of a phone number such as +1 (123) 456-7890, the email security system may determine that the phone number included in the email is validated. In some instances, if there is no association and/or the phone number included in the email has not been validated, the email security system may determine that the incoming email is malicious. In some instances, if it is determined by the email security system that the sending domain has no indication of legitimate phone numbers (e.g., there is no phone number included in a DNS TXT record of the sending domain to be compared to the phone number included in the email), the email security system may rely on other techniques to determine the authenticity of the email (e.g., metadata associated with the email, reputation of the sending domain, etc.). Upon the determination of the validity the phone number included in the email, the email security system may be configured to classify the email as a legitimate callback email (e.g., when there is a match between phone numbers) or a callback phishing attempt email.

At block 712, the process may include processing, by the secure email gateway, the email based at least in part on the association. For example, based on the classification of the email (e.g., whether the email is a legitimate callback email or a callback phishing attempt email), the email security system may process the incoming email accordingly. For example, in instances where the email is a legitimate callback email, the email security system may be configured to forward and/or transmit the email to a receiving user such that the email is delivered to the receiving user's inbox. In another example, in instances where the email is a callback phishing attempt email, the email security system may be configured to perform a remedial action with respect to the callback phishing attempt email. Remedial actions may include quarantining, flagging, deleting, and/or dropping the callback phishing attempt email, preventing further communication received from the sender and/or further communication sharing similarities with the callback phishing attempt email, reporting sender information and/or the phone number to authorities, and/or the like.

Additionally, or alternatively, the process 700 may include wherein processing the email based at least in part on the association includes transmitting, by the secure email gateway, the email to the user account.

Additionally, or alternatively, the process 700 may include wherein the email is a first email, and the sending domain is a first sending domain, receiving, at the secure email gateway, a second email to be processed and delivered to the user account of the email service, wherein the second email includes an indication of a third phone number, determining, based at least in part on first metadata extracted from the second email, a callback intent associated with the second email, determining, based at least in part on second metadata extracted from the second email, a second sending domain associated with the second email, determining a fourth phone number associated with the second sending domain, determining an absence of an association between the third phone number and the fourth phone number, and based at least in part on the absence, refraining from transmitting, by the secure email gateway, the second email to the user account.

Additionally, or alternatively, the process 700 may include wherein determining the second phone number associated with the sending domain further comprises analyzing, based at least in part on the sending domain, domain name system (DNS) records, the DNS records including an indication of the second phone number by an entity associated with the sending domain.

Additionally, or alternatively, the process 700 may include wherein determining the absence of the association between the third phone number and the fourth phone number further comprises analyzing, based at least in part on the second sending domain, DNS records, the DNS records including an indication of the fourth phone number, the fourth phone number being different from the third phone number.

Additionally, or alternatively, the process 700 may include wherein determining, based at least in part on the first metadata extracted from the email, the callback intent associated with the email comprises one or more of analyzing a subject of the email or analyzing contents of the email.

Additionally, or alternatively, the process 700 may include wherein the email is a first email, and the sending domain is a first sending domain, receiving, at the secure email gateway, a second email to be processed and delivered to the user account of the email service, wherein the second email includes an indication of a third phone number, determining, based at least in part on first metadata extracted from the second email, a callback intent associated with the second email, determining, based at least in part on second metadata extracted from the second email, a second sending domain associated with the second email, analyzing domain name system (DNS) records based at least in part on the second sending domain, identifying an absence of an indication of a phone number by an entity associated with the second sending domain, and determining, based at least in part on the absence, a reputation associated with the third phone number.

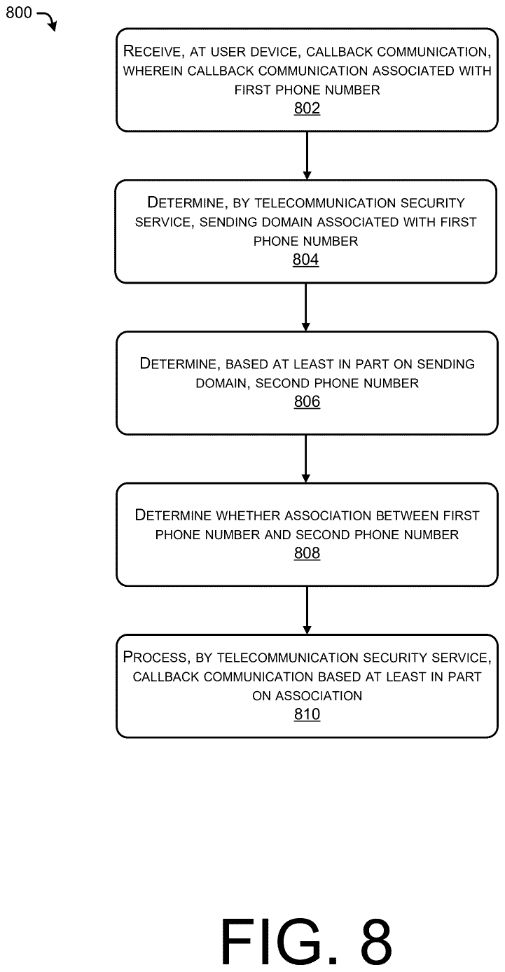

FIG. 8 illustrates a flow diagram of an example process 800 for process for enabling and preventing callback phishing in incoming emails. The techniques may be applied by a system comprising one or more processors, and one or more non-transitory computer-readable media storing computer-executable instructions that, when executed by the one or more processors, cause the one or more processors to perform operations of process 800.

The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, although the processes may be implemented in a wide variety of other environments, architectures and systems.

At block 802, the process may include receiving, at a user device, a callback communication, wherein the callback communication is associated with a first phone number. For example, a telecommunications service platform may use, or work in combination with, a telecommunications security system. The telecommunications security system (e.g., an application on a user device) may receive, or intercept, telecommunications and/or other types of communications that are to be communicated to and/or from users of the telecommunications service platform. A user of the telecommunications service platform (e.g., a receiving user) may receive a callback (e.g., returning phone call from call center, doctor's office, entity, etc. subsequent to an initial communication) and or attempt to engage in a telecommunication (e.g., the receiving users dials a callback phone number included in an email). For example, a receiving user may have previously engaged in an initial communication with an entity (e.g., a call center) and is receiving a callback to avoid waiting on hold. In another example, a receiving user may have received an email including a request for a confirmation of delivery, and the user may dial the phone number indicated in the email. After receiving a callback communication to and/or from a user (e.g., a receiving user) of the telecommunications service platform, the telecommunications security system may be configured to extract phone number metadata associated with the callback communication. Phone number metadata may include an indication of a phone number (e.g., the phone number being dialed by the receiving user, the phone number associated with the incoming callback communication to the user, etc.), an indication of an entity that is presented as being associated with the phone number, etc. Based on the phone number metadata, the telecommunications security system may be configured to determine a phone number associated with the callback communication.

At block 804, the process may include determining, by a telecommunication security service, a sending domain associated with the first phone number. For example, the telecommunications security system may be configured to determine a sending domain associated with the phone number. For example, a sending domain may include indications such as “acmebank.com.” Based on the phone number, the telecommunications security system may be configured to receive and/or extract a sending domain associated with the phone number from one or more sources. For example, sending domains associated with phone numbers may be aggregated and stored at a single location (e.g., a datastore). Such a datastore may be associated with a DNS (e.g., using a reverse-DNS look-up), a reverse phone number database (e.g., provided by a third-party, ISP, etc.). The telecommunications security system may query, or perform a reverse look-up, such that a sending domain may be determined based on the phone number of the callback. For example, based on a phone number of +1 (111) 111-1111 associated with the callback communication of the receiving user, the telecommunications security system may identify the sending domain as “acmebank.com.” In some instances, if it is determined by the telecommunications security system that the phone number has no indication of legitimate domains, the telecommunications security system may rely on other techniques to determine the authenticity of the callback.

At block 806, the process may include determining, based at least in part on the sending domain, a second phone number. For example, based on the determined sending domain, the telecommunications security system may be configured to receive and/or extract a phone number associated with the sending domain from one or more sources. For example, phone numbers associated with sending domains may be aggregated and stored at a single location (e.g., a datastore). Such a datastore may be associated with a domain name system (DNS) (e.g., the email security system may query DNS records to extract and/or receive a phone number associated with the sending domain). The DNS may be provided by a third-party, internet service provider (ISP), and/or the like. In some instances, DNS records may include DNS TXT records, where the DNS TXT records include information provided by the owner of the sending domain. For example, DNS TXT records may include an indication of one or more phone numbers provided by an entity that is the owner of the sending domain. Phone numbers included in DNS TXT records may be those to be authenticated as legitimate and associated with the entity (e.g., phone numbers used by the entity when engaging in callbacks with customers). DNS records may also include digital certificates authenticating the DNS TXT records (e.g., Verified Mark Certificates (VMCs)). For example, DNS TXT records associated with the sending domain of “acmebank.com” may include an indication of phone numbers such as +1 (123) 456-7890 and +1 (999) 999-9999 that are legitimate callback phone numbers of the acmebank.com sending domain.

At block 808, the process may include determining whether there is an association between the first phone number and the second phone number. For example, once one or more phone numbers associated with the sending domain have been extracted and/or received by the telecommunications security system, the telecommunications security system may be configured to validate the phone number associated with the telecommunication. By way of example, and not limitation, the telecommunications security system may be configured to validate the phone number of an incoming callback communication of the receiving user and/or an attempted callback communication with the phone number by the receiving user by determining whether the phone number is included as part of the DNS TXT record associated with the sending domain. In other words, the telecommunications security system may compare the phone number included in the callback communication to the phone numbers associated with the sending domain to determine whether there is a match. In some instances, the telecommunications security system may be configured to determine whether there is an exact match between the phone number included in the email and the phone numbers included in the DNS TXT records of the sending domain. If there is a match, or association, between phone numbers and/or the phone number associated with the callback communication has been validated, the telecommunications security system may determine that the incoming and/or outcoming callback communication is associated with a legitimate callback attempt. Continuing from the example above, if the phone number of the callback communication is a phone number such as +1 (111) 111-1111, the telecommunications security system may determine that the phone number of the callback communication is not validated and/or potentially malicious. Additionally, or alternatively, if the phone number of the callback communication was a phone number such as +1 (123) 456-7890, the telecommunications security system may determine that the phone number is validated. In some instances, if there is no association and/or the phone number of the callback communication has not been validated, the telecommunications security system may determine that the callback communication is malicious. In some instances, if it is determined by the telecommunications security system that the sending domain has no indication of legitimate phone numbers (e.g., there is no phone number included in a DNS TXT record of the sending domain to be compared to the phone number of the callback communication), the telecommunications security system may rely on other techniques to determine the authenticity of the callback. Upon the determination of the validity the phone number of the callback communication, the telecommunications security system may be configured to classify the callback communication as a legitimate callback communication (e.g., when there is a match between phone numbers), or a malicious callback communication (e.g., associated with callback phishing).

At block 810, the process may include processing, by the telecommunication security service, the callback communication based at least in part on the association. For example, based on the classification of the callback communication (e.g., whether the callback communication is legitimate or malicious), the telecommunications security system may process the incoming and/or outgoing callback communication accordingly. For example, in instances where the callback communication is legitimate, the telecommunications security system may be configured to forward and/or transmit the callback communication of a receiving user such that a communication session may be established. In another example, in instances where the callback communication is malicious, the telecommunications security system may be configured to perform a remedial action with respect to the callback communication. Remedial actions may include dropping the callback communication, preventing further communication received from the sender and/or further communication sharing similarities with the phone number, domain name, etc., blocking and/or flagging the callback communication, reporting sender information and/or the phone number to authorities, notifying the receiving user via the user device of the callback communication, and/or the like.

Additionally, or alternatively, the process 800 may include wherein processing the callback communication based at least in part on the association includes transmitting, by the telecommunication security service, the callback communication to the user device.

Additionally, or alternatively, the process 800 may include wherein the callback communication is a first callback communication, and the sending domain is a first sending domain, receiving, at the user device, a second callback communication, wherein the second callback communication is associated with a third phone number, determining, by the telecommunication security service, a second sending domain associated with the third phone number, determining, based at least in part on the second sending domain, a fourth phone number, determining an absence of an association between the third phone number and the fourth phone number, and based at least in part on the absence, refraining from transmitting the second callback communication to the user device.

Additionally, or alternatively, the process 800 may include wherein the callback communication includes an indication of an entity, the operations further comprising causing display of a notification at the user device based at least in part on the absence, wherein the notification indicates that the third phone number is not associated with the entity.

Additionally, or alternatively, the process 800 may include wherein at least one of the determining the sending domain or the determining the second phone number is based at least in part on analyzing domain name system (DNS) records containing indications of phone numbers by entities.

Additionally, or alternatively, the process 800 may include receiving an email to be processed and delivered to a user account of an email service associated with the user device, wherein the email includes an indication of the first phone number, and determining, based at least in part on metadata extracted from the email, a callback intent associated with the email, wherein receiving the callback communication at the user device further comprises receiving, at the user device, user input including a request to engage in a callback communication session associated with the first phone number.

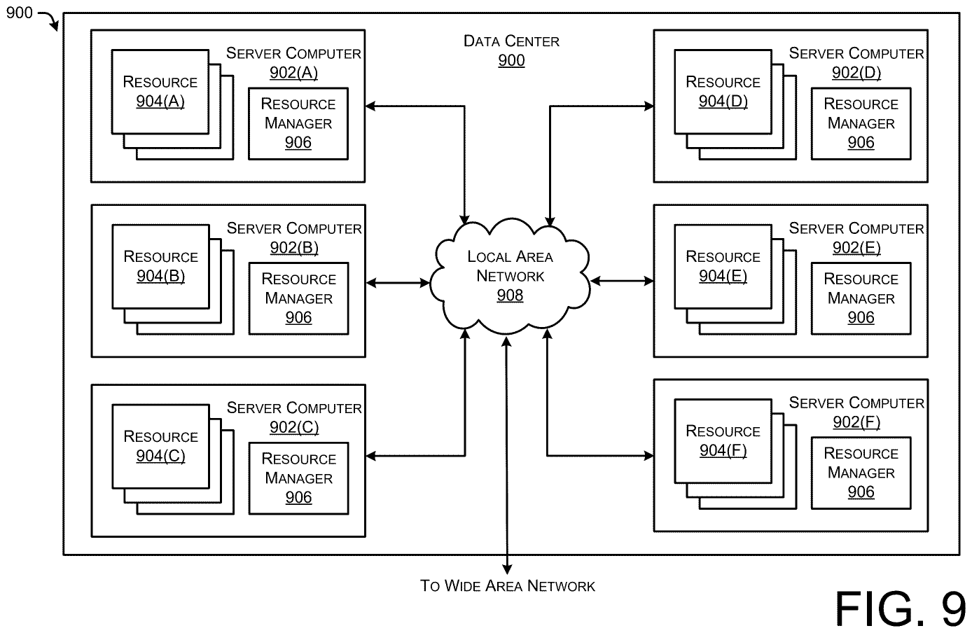

FIG. 9 is a computing system diagram illustrating a configuration for a data center 900 that can be utilized to implement aspects of the technologies disclosed herein. In one example, the data center 900 may be used to support the email security system 104, the telecommunications security system 204, and/or service provider network 132. The example data center 900 shown in FIG. 9 includes several server computers 902A-902F (which might be referred to herein singularly as “a server computer 902” or in the plural as “the server computers 902”) for providing computing resources. In some examples, the resources and/or server computers 902 may include, or correspond to, the any type of networked device described herein. Although described as servers, the server computers 902 may comprise any type of networked device, such as servers, switches, routers, hubs, bridges, gateways, modems, repeaters, access points, etc.

The server computers 902 can be standard tower, rack-mount, or blade server computers configured appropriately for providing computing resources. In some examples, the server computers 902 may provide computing resources 904 including data processing resources such as VM instances or hardware computing systems, database clusters, computing clusters, storage clusters, data storage resources, database resources, networking resources, and others. Some of the server computers 902 can also be configured to execute a resource manager 906 capable of instantiating and/or managing the computing resources. In the case of VM instances, for example, the resource manager 906 can be a hypervisor or another type of program configured to enable the execution of multiple VM instances on a single server computer 902. Server computers 902 in the data center 900 can also be configured to provide network services and other types of services. In one example, server computers 902 may be email security system 104, the telecommunications security system 204, and/or service provider network 132.

In the example data center 900 shown in FIG. 9, an appropriate LAN 908 is also utilized to interconnect the server computers 902A-902F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 900, between each of the server computers 902A-902F in each data center 900, and, potentially, between computing resources in each of the server computers 902. It should be appreciated that the configuration of the data center 900 described with reference to FIG. 6 is merely illustrative and that other implementations can be utilized.

In some examples, the server computers 902 may each execute one or more application containers and/or virtual machines to perform techniques described herein.

In some instances, the data center 900 may provide computing resources, like application containers, VM instances, and storage, on a permanent or an as-needed basis. Among other types of functionality, the computing resources provided by a cloud computing network may be utilized to implement the various services and techniques described above. The computing resources 904 provided by the cloud computing network can include various types of computing resources, such as data processing resources like application containers and VM instances, data storage resources, networking resources, data communication resources, network services, and the like.

Each type of computing resource 904 provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources 904 not mentioned specifically herein.

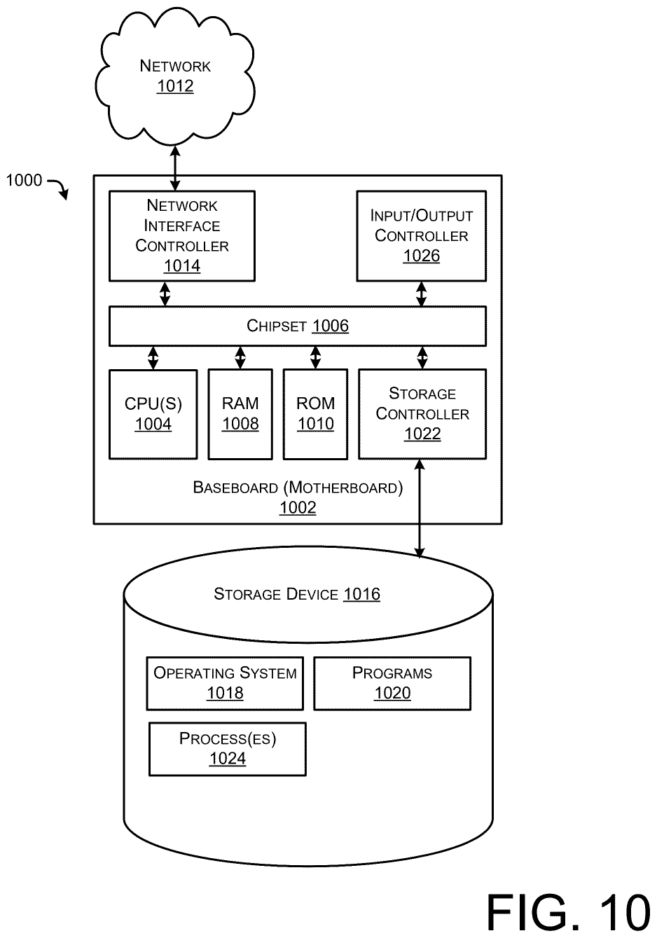

The computing resources 904 provided by a cloud computing network may be enabled in one embodiment by one or more data centers 900 (which might be referred to herein singularly as “a data center 900” or in the plural as “the data centers 900”). The data centers 900 are facilities utilized to house and operate computer systems and associated components. The data centers 900 typically include redundant and backup power, communications, cooling, and security systems. The data centers 900 can also be located in geographically disparate locations. One illustrative embodiment for a data center 900 that can be utilized to implement the technologies disclosed herein will be described below with regard to FIG. 10.

FIG. 10 shows an example computer architecture for a server computer 1000 capable of executing program components for implementing the functionality described above. The computer architecture shown in FIG. 10 illustrates a conventional server computer, workstation, desktop computer, laptop, tablet, network appliance, e-reader, smartphone, or other computing device, and can be utilized to execute any of the software components presented herein. The server computer 1000 may, in some examples, correspond to a network node described herein.

The computer 1000 includes a baseboard 1002, or “motherboard,” which is a printed circuit board to which a multitude of components or devices can be connected by way of a system bus or other electrical communication paths. In one illustrative configuration, one or more central processing units (“CPUs”) 1004 operate in conjunction with a chipset 1006. The CPUs 1004 can be standard programmable processors that perform arithmetic and logical operations necessary for the operation of the computer 1000.

The CPUs 1004 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 1006 provides an interface between the CPUs 1004 and the remainder of the components and devices on the baseboard 1002. The chipset 1006 can provide an interface to a random-access memory (RAM) 1008, used as the main memory in the computer 1000. The chipset 1006 can further provide an interface to a computer-readable storage medium such as a read-only memory (ROM) 1010 or non-volatile RAM (NVRAM) for storing basic routines that help to startup the computer 1000 and to transfer information between the various components and devices. The ROM 1010 or NVRAM can also store other software components necessary for the operation of the computer 1000 in accordance with the configurations described herein.

The computer 1000 can operate in a networked environment using logical connections to remote computing devices and computer systems through a network, such as the network 1012. The chipset 1006 can include functionality for providing network connectivity through a network interface controller (NIC) 1014, such as a gigabit Ethernet adapter. The NIC 1014 is capable of connecting the computer 1000 to other computing devices over the network 1012. It should be appreciated that multiple NICs 1014 can be present in the computer 1000, connecting the computer 1000 to other types of networks and remote computer systems. In some instances, the NICs 1014 may include at least on ingress port and/or at least one egress port.

The computer 1000 can be connected to a storage device 1016 that provides non-volatile storage for the computer. The storage device 1016 can store an operating system 1018, programs 1020, and data, which have been described in greater detail herein. The storage device 1016 can be connected to the computer 1000 through a storage controller 1022 connected to the chipset 1006. The storage device 1016 can consist of one or more physical storage units. The storage controller 1022 can interface with the physical storage units through a serial attached small computer system interface (SCSI) (SAS) interface, a serial advanced technology attachment (SATA) interface, a fiber channel (FC) interface, or other type of interface for physically connecting and transferring data between computers and physical storage units.

The computer 1000 can store data on the storage device 1016 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 1016 is characterized as primary or secondary storage, and the like.

For example, the computer 1000 can store information to the storage device 1016 by issuing instructions through the storage controller 1022 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 1000 can further read information from the storage device 1016 by detecting the physical states or characteristics of one or more particular locations within the physical storage units.

In addition to the mass storage device 1016 described above, the computer 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 1000. In some examples, the operations performed by any network node described herein may be supported by one or more devices similar to computer 1000. Stated otherwise, some or all of the operations performed by a network node may be performed by one or more computers 1000 (e.g., computer devices) operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 1016 can store an operating system 1018 utilized to control the operation of the computer 1000. According to one embodiment, the operating system comprises the LINUX™ operating system. According to another embodiment, the operating system includes the WINDOWS™ SERVER operating system from MICROSOFT Corporation of Redmond, Washington. According to further embodiments, the operating system can comprise the UNIX™ operating system or one of its variants. It should be appreciated that other operating systems can also be utilized. The storage device 1016 can store other system or application programs and data utilized by the computer 1000.

In one embodiment, the storage device 1016 or other computer-readable storage media is encoded with computer-executable instructions which, when loaded into the computer 1000, transform the computer from a general-purpose computing system into a special-purpose computer capable of implementing the embodiments described herein. These computer-executable instructions transform the computer 1000 by specifying how the CPUs 1004 transition between states, as described above. According to one embodiment, the computer 1000 has access to computer-readable storage media storing computer-executable instructions which, when executed by the computer 1000, perform the various processes described above with regard to FIGS. 1-9. The computer 1000 can also include computer-readable storage media having instructions stored thereupon for performing any of the other computer-implemented operations described herein.

As illustrated in FIG. 10, the storage device 1016 stores programs 1020, which may include one or more processes 1024. The process(es) 1024 may include instructions that, when executed by the CPU(s) 1004, cause the computer 1000 and/or the CPU(s) 1004 to perform one or more operations.

The computer 1000 can also include at least one input/output controller 1026 for receiving and processing input from a number of input devices, such as a keyboard, a mouse, a touchpad, a touch screen, an electronic stylus, or other type of input device. Similarly, an input/output controller 1026 can provide output to a display, such as a computer monitor, a flat-panel display, a digital projector, a printer, or other type of output device. It will be appreciated that the computer 1000 might not include all of the components shown in FIG. 10, can include other components that are not explicitly shown in FIG. 10, or might utilize an architecture completely different than that shown in FIG. 10.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.” As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving, at a secure email gateway, an email to be processed and delivered to a user account of an email service, wherein the email is associated with an indication of a first phone number;
determining, based at least in part on first metadata extracted from the email, a callback intent associated with the email;
determining, based at least in part on second metadata extracted from the email, a sending domain associated with the email;
determining, a second phone number associated with the sending domain;
determining whether there is an association between the first phone number and the second phone number; and
processing, by the secure email gateway, the email based at least in part on the association.

2. The method of claim 1, wherein processing the email based at least in part on the association includes transmitting, by the secure email gateway, the email to the user account.

3. The method of claim 1, wherein the email is a first email, and the sending domain is a first sending domain, the method further comprising:
receiving, at the secure email gateway, a second email to be processed and delivered to the user account of the email service, wherein the second email includes an indication of a third phone number;
determining, based at least in part on first metadata extracted from the second email, a callback intent associated with the second email;
determining, based at least in part on second metadata extracted from the second email, a second sending domain associated with the second email;
determining a fourth phone number associated with the second sending domain;
determining an absence of an association between the third phone number and the fourth phone number; and
based at least in part on the absence, refraining from transmitting, by the secure email gateway, the second email to the user account.

4. The method of claim 1, wherein determining the second phone number associated with the sending domain further comprises analyzing, based at least in part on the sending domain, domain name system (DNS) records, the DNS records including an indication of the second phone number by an entity associated with the sending domain.

5. The method of claim 3, wherein determining the absence of the association between the third phone number and the fourth phone number further comprises analyzing, based at least in part on the second sending domain, DNS records, the DNS records including an indication of the fourth phone number, the fourth phone number being different from the third phone number.

6. The method of claim 1, wherein determining, based at least in part on the first metadata extracted from the email, the callback intent associated with the email comprises one or more of analyzing a subject of the email or analyzing contents of the email.

7. The method of claim 1, wherein the email is a first email, and the sending domain is a first sending domain, the method further comprising:
receiving, at the secure email gateway, a second email to be processed and delivered to the user account of the email service, wherein the second email includes an indication of a third phone number;
determining, based at least in part on first metadata extracted from the second email, a callback intent associated with the second email;
determining, based at least in part on second metadata extracted from the second email, a second sending domain associated with the second email;
analyzing domain name system (DNS) records based at least in part on the second sending domain;
identifying an absence of an indication of a phone number by an entity associated with the second sending domain; and
determining, based at least in part on the absence, a reputation associated with the third phone number.

8. A system comprising:
one or more processors; and
one or more non-transitory computer-readable media storing computer-executable instructions that, when executed by the one or more processors, cause the system to perform operations comprising:
receiving, at a user device, a callback communication, wherein the callback communication is associated with a first phone number;
determining, by a telecommunication security service, a sending domain associated with the first phone number;
determining, based at least in part on the sending domain, a second phone number;
determining whether there is an association between the first phone number and the second phone number; and
processing, by the telecommunication security service, the callback communication based at least in part on the association.

9. The system of claim 8, wherein processing the callback communication based at least in part on the association includes transmitting, by the telecommunication security service, the callback communication to the user device.

10. The system of claim 8, wherein the callback communication is a first callback communication, and the sending domain is a first sending domain, the operations further comprising:
receiving, at the user device, a second callback communication, wherein the second callback communication is associated with a third phone number;
determining, by the telecommunication security service, a second sending domain associated with the third phone number;
determining, based at least in part on the second sending domain, a fourth phone number;
determining an absence of an association between the third phone number and the fourth phone number; and
based at least in part on the absence, refraining from transmitting the second callback communication to the user device.

11. The system of claim 10, wherein the callback communication includes an indication of an entity, the operations further comprising causing display of a notification at the user device based at least in part on the absence, wherein the notification indicates that the third phone number is not associated with the entity.

12. The system of claim 8, wherein at least one of the determining the sending domain or the determining the second phone number is based at least in part on analyzing domain name system (DNS) records containing indications of phone numbers by entities.

13. The system of claim 8, the operations further comprising:
receiving an email to be processed and delivered to a user account of an email service associated with the user device, wherein the email includes an indication of the first phone number; and
determining, based at least in part on metadata extracted from the email, a callback intent associated with the email,
wherein receiving the callback communication at the user device further comprises receiving, at the user device, user input including a request to engage in a callback communication session associated with the first phone number.

14. One or more non-transitory computer-readable media storing computer-executable instructions that, when executed by one or more processors, cause the one or more processors to perform operations comprising:
receiving, at a secure email gateway, an email to be processed and delivered to a user account of an email service, wherein the email is associated with an indication of a first phone number;
determining, based at least in part on first metadata extracted from the email, a callback intent associated with the email;
determining, based at least in part on second metadata extracted from the email, a sending domain associated with the email;
determining, a second phone number associated with the sending domain;
determining whether there is an association between the first phone number and the second phone number; and
processing, by the secure email gateway, the email based at least in part on the association.

15. The one or more non-transitory computer-readable media of claim 14, wherein processing the email based at least in part on the association includes transmitting, by the secure email gateway, the email to the user account.

16. The one or more non-transitory computer-readable media of claim 14, wherein the email is a first email, and the sending domain is a first sending domain, the operations further comprising:
receiving, at the secure email gateway, a second email to be processed and delivered to the user account of the email service, wherein the second email includes an indication of a third phone number;
determining, based at least in part on first metadata extracted from the second email, a callback intent associated with the second email;
determining, based at least in part on second metadata extracted from the second email, a second sending domain associated with the second email;
determining a fourth phone number associated with the second sending domain;
determining an absence of an association between the third phone number and the fourth phone number; and
based at least in part on the absence, refraining from transmitting, by the secure email gateway, the second email to the user account.

17. The one or more non-transitory computer-readable media of claim 14, wherein determining the second phone number associated with the sending domain further comprises analyzing, based at least in part on the sending domain, domain name system (DNS) records, the DNS records including an indication of the second phone number by an entity associated with the sending domain.

18. The one or more non-transitory computer-readable media of claim 16, wherein determining the absence of the association between the third phone number and the fourth phone number further comprises analyzing, based at least in part on the second sending domain, DNS records, the DNS records including an indication of the fourth phone number, the fourth phone number being different from the third phone number.

19. The one or more non-transitory computer-readable media of claim 14, wherein determining, based at least in part on the first metadata extracted from the email, the callback intent associated with the email comprises one or more of analyzing a subject of the email or analyzing contents of the email.

20. The one or more non-transitory computer-readable media of claim 14, wherein the email is a first email, and the sending domain is a first sending domain, the operations further comprising:
receiving, at the secure email gateway, a second email to be processed and delivered to the user account of the email service, wherein the second email includes an indication of a third phone number;
determining, based at least in part on first metadata extracted from the second email, a callback intent associated with the second email;
determining, based at least in part on second metadata extracted from the second email, a second sending domain associated with the second email;
analyzing domain name system (DNS) records based at least in part on the second sending domain;
identifying an absence of an indication of a phone number by an entity associated with the second sending domain; and
determining, based at least in part on the absence, a reputation associated with the third phone number.
